(19) United States
(12) Patent Application Publication
(10) Pub. No.: US 2023/0374362 A1
(43) Pub. Date: Nov. 23, 2023

(54) Refrigeration Systems and Methods

(71) Applicant: HONEYWELL INTERNATIONAL INC., Charlotte, NC (US)

(72) Inventors: Kaimi Gao, Charlotte, NC (US); Nilesh Purohit, Buffalo, NY (US); Ankit SETHI, Buffalo, NY (US); Nitin Karwa, Bangalore (IN); Samuel F. YANA MOTTA, Charlotte, NC (US); Gustavo POTTKER, Charlotte, NC (US)

(73) Assignee: HONEYWELL INTERNATIONAL INC., Charlotte, NC (US)

(21) Appl. No.: 18/200,086

(22) Filed: May 22, 2023

Related U.S. Application Data
(60) Provisional application No. 63/344,542, filed on May 21, 2022.
(60) Provisional application No. 63/432,882, filed on Dec. 15, 2022.

(51) Int. Cl. C09K 5/04; F25B 9/00; F25B 9/10

(52) U.S. Cl. CPC C09K 5/045; F25B 9/006; F25B 9/10; C09K 2205/22; C09K 2205/126; C09K 2205/122; C09K 2205/40

(57) ABSTRACT

Disclosed are refrigerants and refrigeration systems, including cascade refrigeration sysemsar comprising: a plurality of refrigeration units, each refrigeration unit containing a first refrigeration circuit, each first refrigeration circuit comprising an evaporator and a heat exchanger; and a second refrigeration circuit; wherein each first circuit heat exchanger is arranged to transfer heat energy between its respective first refrigeration circuit and the second refrigeration circuit.

### CROSS REFERENCE TO RELATED APPLICATIONS

This application is related to and incorporates by reference each of U.S. Provisional Application No. 63/344,542, filed May 21, 2022, and U.S. Provisional Application No. 63/432,882, filed Dec. 15, 2022.

### FIELD

The present invention relates to high efficiency, low-global warming potential (“low GWP”) refrigerants and to air conditioning and/or refrigeration systems and methods for providing cooling that are safe and effective. Particular embodiments relate to commercial refrigeration and to cascade refrigeration systems and methods, particularly, but not exclusively, to commercial refrigeration (including commercial cascade refrigeration systems and methods) having exceptional performance in use with certain low GWP refrigerants.

### BACKGROUND

The refrigeration industry is under increasing pressure—through regulatory changes and otherwise—to replace refrigerants that have global warming potential (GWP) values that are relatively high, such as HFC-134a and R404A, with materials that have a lower GWP. Under many current regulations, and regulations that are contemplated for the future, refrigerants need to have a GWP below 150. The use of refrigerants with GWP values of below 150 is of particularly importance in the commercial refrigeration system, where high volumes of refrigerant are used, and in such uses potential negative environment impact is very great if refrigerants with substantially higher GWP are used.

One approach has been to use low GWP refrigerants, such as carbon dioxide (R744) and hydrocarbon refrigerants. However, such an approach as has been heretofore used can suffer from significant safety and financial drawbacks, such as: poor system energy efficiency, leading to increased operating costs; high system complexity, leading to high initial system costs; low system serviceability and reliability, leading to high maintenance costs; and high system flammability. Systems which include highly flammable refrigerants according to prior arrangements have been particularly disadvantageous as they can lead to poor levels of safety; can conflict with regulatory code restrictions; and can increase liability on refrigeration system operators and manufacturers. Safety is a particular concern given that many commercial refrigeration applications, such as supermarket fridges, freezers and cold display cases are publicly accessible and often operate in densely populated spaces.

Another approach has been to provide new refrigerants with a GWP lower than that of HFC-134a, but this approach has frequently not successfully produced a refrigerant with a GWP value of 150 or less. For example, US Patent Application 2021/0198547 discloses an attempt to provide a refrigerant having a GWP less than that of HFC-134a that also provides an efficiency in use that is equal to or higher than HFC-134a by using a refrigerant blend that comprises HFO-1234ze(E) and HFC-134. However, this effort was ineffective in that it does not reveal an ability to provide a refrigerant with a GWP of less than 150 that also provides other desirable qualities, such as non-flammability and good heat transfer performance. In particular, the '547 application discloses 11 specific refrigerant blends, and all those refrigerant blends have a GWP of greater than 300. In this sense at least, therefore, the refrigerants of the '547 application do not achieve the combination of properties, including GWP below 150, that are an object of the preferred aspects of the present invention. For example, a refrigerant comprising 63% by weight of HFO-1234ze(E), 35% by weight of HFC-134 and 2% by weight of R1244yd is disclosed, but this refrigerant blend has a GWP of 389. Similar ineffective results are disclosed for the ten (10) other blends that are specifically disclosed in the '547 application.

Applicants have come to appreciate, therefore, that the refrigeration industry continues to need safe, robust, and sustainable approaches for reducing the use of high GWP refrigerants which can be used with existing technologies, and in particular for a refrigerant that has a GWP below 150 while at the same time providing a capacity that is 65% or greater compared to prior refrigerants (including R-134a), non-flammability and relatively low glide.

The prior art has also been searching for an improved cascade refrigeration system that provides advantageous operation in terms of environmental friendliness. One example of a typical cascade refrigeration system, as shown in FIG. 6A, is a system 100 of the type that is commonly used for commercial refrigeration in supermarkets. The system 100 is a direct expansion system which provides both medium and low temperature refrigeration via medium temperature refrigeration circuit 110 and low temperature refrigeration circuit 120. In such a typical configuration, the medium temperature refrigeration circuit 110 has R134a as its refrigerant. The medium temperature refrigeration circuit 110 provides both the medium temperature cooling and removes the rejected heat from the lower temperature refrigeration circuit 120 via a heat exchanger 130. The medium temperature refrigeration circuit 110 extends between a roof 140, a machine room 141 and a sales floor 142. The low temperature refrigeration circuit 120 on the other hand has R744 as its refrigerant. The low temperature refrigeration circuit 120 extends between the machine room 141 and the sales floor 142. Usefully, as discussed above, R744 has a low GWP.

However, while refrigeration systems of the type disclosed in FIG. 6A may be able to provide good efficiency levels, applicants have come to appreciate that systems of this type have at least two major drawbacks: first, such systems use the high GWP refrigerant R134a (R134a having a GWP of around 1300); and second, even though the low temperature portions of such systems uses the low GWP refrigerant R744, this refrigerant exhibits many of the drawbacks discussed above, including significant safety and financial drawbacks.

Furthermore, in certain refrigeration applications, it is necessary to cool articles but without exposing those articles to temperatures below a certain temperature, such as the freezing point of water. For example, it is common in a supermarket environment to keep certain produce at a reduced temperature relative to the ambient, but at the same time it is disadvantageous to cool that produce below the freezing point of water, especially since the preferred method of cooling involves indirect cooling with humid, ambient air. For these applications, it is also disadvantageous to have, along the evaporator, refrigerant temperatures below freezing point of water, as they will cause frost accumulation and consequently the need to defrost the equipment. Avoiding frost accumulation is an important aspect in those applications. Similarly, cooling of beverages, including water and the like, should also be conducted under conditions which avoid exposing such products to temperatures below the freezing point of water since freezing of such products is not desirable at the point of sale. For the purpose of convenience, applicants will refer herein to such applications, methods and systems as “no-freeze” applications, methods and systems.

Certain single-component fluorocarbons, including chlorofluorocarbons (“CFCs”), hydrochlorofluorocarbons (“HCFCs”), and hydrofluorolefins (“HFOs”), have been used in “no frost” applications in which the refrigerant temperature along the evaporator must remain above the freezing point of water so that frost does not accumulate on the coil surface and, consequently, defrost is not required In such refrigeration applications, systems and methods, the use of single component fluids has heretofore been considered particularly desirable because the saturation temperature of such fluids does not change upon evaporation of the fluid at constant pressure. This is highly desirable because it permits the system or method to be designed with a refrigerant temperature along the evaporator that remains essentially constant during the evaporation processes, and above the freezing temperature of water, assuming little or no pressure drop as the refrigerant flows through the evaporator. In addition, produce applications also typically require small temperature difference between air and refrigerant to reduce the dehumidification of the air and consequent removal of moisture content and loss of quality of the produce. The requirements of small temperature differences and avoiding frost formation combined with the need for the evaporator to have a certain positive degree of superheat at the exit are critical in selecting a specific refrigerant. A degree of superheat equal or below zero, i.e., refrigerant is not superheated, may lead to reduction in cooling capacity, efficiency and potential compressor failure. The term “degree of superheat” or simply “superheat” means the temperature rise of the refrigerant at the exit of the evaporator above the saturated vapor temperature (or dew temperature) of the refrigerant.

This is illustrated, by way of example in FIG. 6B, which represents in schematic form a typical supermarket produce cooling case. Typically, as illustrated in FIG. 6, cooled, moisture-bearing air is provided to the product display zone of the display case by passing air, both from outside of the case 102 and from recirculating air 104, over the heat exchange surface of an evaporator coil 106 disposed within the display case in a region which is typically separate from (or at least hidden from the view of the consumer) but near to the product display zone. The evaporator 106 has a single component refrigerant inlet 108 and a single component refrigerant outlet 110. A circulating fan 114 is also used. It is highly desirable in systems of the type illustrated above that the cooled space 112 in the refrigeration system has a refrigerant temperature along the evaporator that always or substantially always is above a certain level. For example, in many applications such as refrigeration of produce, the minimum discharge (exit) temperature of the air in the display case is set by design to be about 2° C. to 3° C. in order to provide a margin of safety for avoidance of having a cooled space or cooled article that is below the freezing point of water. In addition, in order to minimize the removal of moisture from the air and consequent drying of produce (loss of quality), the temperature difference between air exit and refrigerant needs to be small, typically 2° C. to 3° C. This, combined with the fact that the evaporator of these applications requires a degree of superheat of about 3 to about 5° C., will impose a constraint on the allowable evaporator glide of the refrigerant so that the evaporation temperature remains above the freezing point of water and, as a result, frost does not accumulate.

Those skilled in the art will appreciate that these two desirable results have heretofore been frequently very difficult to provide with refrigerants that are multi-component blends of different single component refrigerants.

For example, while HFC-134a has heretofore been used for certain no-freeze applications, it nevertheless fails to satisfy, for example, the low GWP requirement (item 4 above), as HFC-134a has a GWP of about 1300.

Applicants proceeded in a manner contrary to the accepted wisdom and discovered unexpected and advantageous results. For example, Applicants have found, as described in detail hereinafter, that certain blends comprising a carefully selected combination of components can have an advantageous but unexpected combination of non-flammability while at the same time having excellent heat transfer properties, low GWP (e.g., a GWP of less than about 150), low- or no-toxicity, chemical stability, and lubricant compatibility, among others. Furthermore, Applicants have found that the refrigerant compositions of the present invention have particular advantage for use in medium temperature refrigeration systems, and particularly in medium temperature refrigeration systems in which it is desired to maintain the cooled-air temperature above about 0° C., and other particular embodiments to also avoid exposing the air being cooled to temperatures below about 0° C., in order to protect the articles being cooled from frost and/or to prevent frosting of the evaporator coils, which itself may have a negative impact on the overall efficiency of such systems due to the need for defrosting and/or inconsistent cooling across the coils.

One or more of these and other unmet needs in the prior art are satisfied by the present invention, as explained in detail herein.

### SUMMARY

Applicants have discovered refrigerant compositions, heat transfer compositions comprising the refrigerant, refrigeration methods and systems, including cascade heat transfer methods and systems, and/or to methods and systems for cooling materials that have low temperature constraints, such as low- or no-freeze applications described above.

Medium temperature refrigeration systems and methods, and commercial refrigeration systems and methods, are also provided by the present invention, as described in detail hereinafter.

The refrigerants of the present invention preferably have a GWP of less than about 150, are classified as A1 (non-flammable and low toxicity) by ASHRAE and have an evaporator glide of less than 4.5° C., or less than about 4° C., or less than about 3.5° C., or less than 2.5° C. This means that the inventive refrigerants according to such embodiments are able to achieve an unexpectedly small change in refrigerant temperature through the evaporator.

The present invention also includes refrigerants consisting essentially of:
from about 75% to about 86% by weight of HFO-1234ze(E),
from 5% to less than 11% by weight of HFC-134a; and
from about 5% to about 16% by weight of HFO-1224yd(Z). The refrigerant according to this paragraph is sometimes referred to herein for convenience as Refrigerant 1.

The present invention also includes refrigerants consisting essentially of:
from 74% to 86% by weight of HFO-1234ze(E),
from 5% to 10% or less by weight of HFC-134a; and
from 4% to 16% by weight of HFO-1224yd(Z). The refrigerant according to this paragraph is sometimes referred to herein for convenience as Refrigerant 2.

The present invention also includes refrigerants consisting essentially of:
from 76% to 86% by weight of HFO-1234ze(E),
about 10% or less by weight of HFC-134a; and
from 4% to 14% by weight of HFO-1224yd(Z). The refrigerant according to this paragraph is sometimes referred to herein for convenience as Refrigerant 3.

The present invention also includes refrigerants consisting essentially of:
from about 78% to 86% by weight of HFO-1234ze(E),
about 10% or less by weight of HFC-134a; and
from 4% to about 12% by weight of HFO-1224yd(Z). The refrigerant according to this paragraph is sometimes referred to herein for convenience as Refrigerant 4.

The present invention also includes refrigerants consisting essentially of:
about 84% by weight of HFO-1234ze(E),
10% or less by weight of HFC-134a; and
about 6% by weight of HFO-1224yd(Z). The refrigerant according to this paragraph is sometimes referred to herein for convenience as Refrigerant 5.

The present invention also includes refrigerants consisting of:
about 82% by weight of HFO-1234ze(E),
10% or less by weight of HFC-134a; and
about 8% by weight of HFO-1224yd(Z). The refrigerant according to this paragraph is sometimes referred to herein for convenience as Refrigerant 6.

The present invention also includes refrigerants consisting of:
about 80% by weight of HFO-1234ze(E),
10% or less by weight of HFC-134a; and
about 10% by weight of HFO-1224yd(Z). The refrigerant according to this paragraph is sometimes referred to herein for convenience as Refrigerant 7.

The present invention also includes refrigerants consisting essentially of:
84%+2/−2% by weight of HFO-1234ze (E),
10%+0.5/−2% by weight of HFC-134a; and
6%+2/−2% by weight of HFO-1224yd(Z). The refrigerant according to this paragraph is sometimes referred to herein for convenience as Refrigerant 8A.

The present invention also includes refrigerants consisting essentially of:
83.5%+0.5/−2% by weight of HFO-1234ze (E),
10%+2/−0.5% by weight of HFC-134a; and
6.5%+2/−0.5% by weight of HFO-1224yd(Z). The refrigerant according to this paragraph is sometimes referred to herein for convenience as Refrigerant 8B.

The present invention also includes refrigerants consisting of:
83.5%+0.5/−2% by weight of HFO-1234ze (E),
10%+2/−0.5% by weight of HFC-134a; and
6.5%+2/−0.5% by weight of HFO-1224yd(Z). The refrigerant according to this paragraph is sometimes referred to herein for convenience as Refrigerant 8C.

The present invention also includes refrigerants consisting essentially of:
from about 74% to about 86% by weight of HFO-1234ze(E),
from 5% to less than 12% by weight of HFC-134a; and
from about 4% to about 16% by weight of HFO-1224yd(Z), provided that the refrigerant has an evaporator glide of 4.5° C. or less, a GWP of less than 150 and is a Class A1 non-flammable refrigerant. The refrigerant according to this paragraph is sometimes referred to herein for convenience as Refrigerant 9.

The present invention also includes refrigerants consisting essentially of:
from about 76% to 86% by weight of HFO-1234ze(E),
from 5% to less than 12% by weight of HFC-134a; and
from about 4% to about 14% by weight of HFO-1224yd(Z), provided that the refrigerant has an evaporator glide of 4° C. or less, a GWP of less than 150 and is a Class A1 non-flammable refrigerant. The refrigerant according to this paragraph is sometimes referred to herein for convenience as Refrigerant 10.

The present invention includes a method of providing cooling comprising:
a. providing a vapor compression refrigeration system comprising a compressor, a condenser, an evaporator and a refrigerant comprising:
   i. from about 74% to about 86% by weight of HFO-1234ze(E),
   ii. less than 12% by weight of HFC-134a; and
   iii. from about 4% to about 16% by weight of HFO-1224yd(Z); and
b. evaporating said refrigerant in said evaporator, wherein the glide of said refrigerant in said evaporator is 4.5° C. or less and wherein said refrigerant has a capacity in said system that is greater than 65% of the capacity of R-134a in said system.

The method according to this paragraph is sometimes referred to herein for convenience as Heat Transfer Method 1.

The present invention includes a method of providing cooling comprising:
a. providing a vapor compression refrigeration system comprising a compressor, a condenser, an evaporator and refrigerant according to any one of Refrigerant 1-10; and
b. evaporating said refrigerant in said evaporator, wherein the glide of said refrigerant in said evaporator is 4.5° C. or less and wherein said refrigerant has a capacity in said system that is greater than 65% of the capacity of R-134a in said system.

The method according to this paragraph is sometimes referred to herein for convenience as Heat Transfer Method 2.

The present invention includes a method of providing cooling comprising:
a. providing a vapor compression refrigeration system comprising a compressor, a condenser, an evaporator and a refrigerant comprising:
   i. from 65% to less than 85% by weight of HFO-1234ze(E),
   ii. less than 12% by weight of HFC-134a; and
   iii. from about 10% to about 22% by weight of HFO-1336mzz(E); and
b. evaporating said refrigerant in said evaporator, wherein refrigeration system comprises a high temperature heat pump system or an extreme temperature air conditioning system. The method according to this paragraph is sometimes referred to herein for convenience as Heat Transfer Method 3A.

The present invention includes a method of providing cooling comprising:
a. providing a vapor compression refrigeration system comprising a compressor, a condenser, an evaporator and a refrigerant comprising:
   i. from 70% to less than 80% by weight of HFO-1234ze(E),
   ii. less than 11% by weight of HFC-134a; and
   iii. from about 10% to about 15% by weight of HFO-1336mzz(E); and
b. evaporating said refrigerant in said evaporator, wherein refrigeration system comprises a high temperature heat pump system or an extreme temperature air conditioning system. The method according to this paragraph is sometimes referred to herein for convenience as Heat Transfer Method 3B.

The present invention includes a method of providing cooling comprising:
a. providing a vapor compression refrigeration system comprising a compressor, a condenser, an evaporator and a refrigerant consisting essentially of HDR165; and
b. evaporating said refrigerant in said evaporator, wherein refrigeration system comprises a high temperature heat pump system or an extreme temperature air conditioning system. The method according to this paragraph is sometimes referred to herein for convenience as Heat Transfer Method 3C.

As used herein, reference to a defined system or method or refrigerants, etc. by reference to a range of defined numbered systems, methods, refrigerants, etc., such as Heat Transfer Methods 1-3, includes all methods so defined, including any numbered method that includes a suffix, such as Heat Transfer Methods 1-3 means that each of Heat Transfer Methods 1, Heat Transfer Methods 2, Heat Transfer Methods 3A, Heat Transfer Methods 3B and Heat Transfer Methods 3C are specifically included.

The present invention includes cascade refrigeration systems which comprise (a) a low a stage refrigeration circuit comprising: (i) a low stage refrigerant, preferably having a GWP of about 150 or less; and (i) a compressor; (b) an inter-circuit heat exchanger in which said low stage refrigerant condenses; and (c) a high stage refrigeration circuit comprising a high stage refrigerant which: (i) has a Class 1A or a Class A2L flammability; and (ii) evaporates at a temperature below said low stage refrigerant condensing temperature; and (iii) comprises at least about 74% by weight of HFO-1234ze(E), wherein said high stage refrigerant evaporates in said inter-circuit heat exchanger by absorbing heat from said refrigerant in said low stage refrigeration circuit. Such cascade refrigeration circuits are described in detail hereinafter.

### BRIEF DESCRIPTION OF THE FIGURES

FIG. 1 is a schematic representation of an exemplary heat transfer system useful in air conditioning, low temperature refrigeration and medium temperature refrigeration.

FIG. 2 is a schematic representation of an exemplary heat transfer system useful in low and medium temperature refrigeration and which includes a vapor injector.

FIG. 3 is a schematic representation of an exemplary heat transfer system useful in low and medium temperature refrigeration and which includes a liquid injector.

FIG. 4 is a schematic representation of an exemplary heat transfer system useful in low and medium temperature refrigeration and which includes a suction line/liquid line heat exchanger.

FIG. 5 is a schematic representation of an exemplary heat transfer system useful in low and medium temperature refrigeration and which includes a vapor injector and an oil separator.

FIG. 6A represents in schematic form a typical cascade refrigeration system.

FIG. 6B represents in schematic form a typical supermarket produce cooling case.

FIG. 7 shows a cascaded refrigeration system useful in accordance with the present invention.

FIG. 8 shows an alternative cascaded refrigeration system useful in accordance with the present invention.

### DETAILED DESCRIPTION

### Definitions

As used herein, the terms “low stage” and “high stage” are used in a relative context to designate the relative evaporation temperatures of two or more cascaded refrigeration circuits. Thus, the term “low stage” in the context of a cascaded refrigeration system refers to the refrigeration circuit in which the refrigerant evaporates at temperature that is less than the evaporation temperature of the refrigerant in the “high stage.”

As used herein, the term “cascade refrigeration” refers to a refrigeration system having a low stage refrigerant vapor that is cooled, and preferably condensed, at least in part by rejecting heat to the high stage refrigerant.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R.C. Downing, FLUOROCARBON REFRIGERANTS HANDBOOK, Chapter 3, Prentice-Hall, 1988 which is incorporated herein by reference in its entirety).

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fifth Assessment Report, 2014¹, referred to and abbreviated herein as AR5. ¹ Myhre, G., D. Shindell, F.-M. Bréon, W. Collins, J. Fuglestvedt, J. Huang, D. Koch, J.-F. Lamarque, D. Lee, B. Mendoza, T. Nakajima, A. Robock, G. Stephens, T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker, T. F., D. Qin, G.-K. Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar5/wg1/WG1AR5_Chapter08_FINAL.pdf (p. 73-79)

The term “non-flammable” refers to compounds or compositions which are determined to be nonflammable as determined in accordance with ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2016 Designation and Safety Classification of Refrigerants test protocol defining conditions and apparatus and using the current method ASTM E681-09 annex A1 (as each standard exists as of the filing date of this application).

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase ‘saturation temperature” means the temperature at which the liquid refrigerant boils into vapor at a given pressure.

The phrase “no or low toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

The term “degree of superheat” or simply “superheat” means the temperature rise of the refrigerant at the exit of the evaporator above the saturated vapor temperature (or dew temperature) of the refrigerant.

As used herein, the term “E-1,3,3,3-tetrafluoropropene” means the trans isomer of HFO-1234ze and is abbreviated as HFO-1234ze (E).

As used herein, the term “Z-1-chloro-2,3,3,3-tetrafluoropropene” means the cis isomer of HFCO-1224yd and is abbreviated as HFCO-1224yd(Z).

As used herein, the term “1,1,1,2-tetrafluoroethane” is abbreviated as HFC-134a.

As used herein, the term “1,1,2,2-tetrafluoroethane” is known in the industry by the abbreviation HFC-134 and is abbreviated herein as HFC-134.

As used herein, the term “E-1,1,1,4,4,4-hexafluorobut-2-ene” means the trans isomer of HFO-1336mzz and is abbreviated as HFO-1336mzz (E).

As used herein, the term “1,1,1,2,3,3,3-heptafluoropropane” is abbreviated as HFC-227ea.

As used herein, the term “difluoromethane” means CH₂F₂ and is abbreviated as HFC-32.

As used herein, the term “low temperature refrigeration” refers to a refrigeration system that operates under or within the following conditions: (a) condenser temperature from about 15° C. to about 50° C.; and (b) evaporator temperature from about −40° C. to about or less than about −15° C.

As used herein, the term “medium temperature refrigeration” refers to a refrigeration system that utilizes one or more compressors and operates under or within the following conditions: (a) a condenser temperature of from about 15° C. to about 60° C.; and (b) evaporator temperature of from about −15° C. to about 5° C.

As used herein the term “extreme temperature air conditioning system” means a vapor compression air conditioning system in which the condensing temperature of the refrigerant is from about 55° C. to about 95° C.

As used herein the term “high temperature heat pump system” means a vapor compression system operable in a heating mode in which the condensing temperature of the refrigerant is from about 55° C. to about 95° C.

As used herein, the term “R454C” means the refrigerant designated by ASHRAE as 454C and which consists of 21.5%+2/−2% of R-32 and 78.5+2/−2% of HFC-1234yf.

As used herein, the term “R455A” means the refrigerant designated by ASHRAE as 455AC and which consists of 21.5%+2/−1% of R-32, 75.5 of HFC-1234yf+2/−2% and 3%+2/−1% of CO₂.

As used herein, the term “R471A” means the refrigerant designated by ASHRAE as 471A and which consists of 78.7%+0.4/−1.5% of HFC-1234ze(E), 17%+1.5/−0.4% of HFC-1336mzz(E) and 4.3%+1.5/−0.4% of HFC-227ea.

As used herein, the term “HDR165” means the refrigerant which consists of 78.7%+/−+0.5/−2% of HFC-1234ze(E), 12%+2/−0.5% of HFC-1336mzz(E) and 10%+2/−0.5% of HFC-134a.

As used herein, the term “HDR166” means the refrigerant consisting of 83.5%+0.5/−2% of HFC-1234ze(E), 6.5+2%/−0.5% of HFCO-1224yd(Z) and 10%+2%/−0.5% of HFC-134a.

As used herein, the term “about” in relation to the amount expressed in weight percent means that the amount of the component can vary by an amount of +/−2% by weight.

Refrigerants and Heat Transfer Compositions:

Applicants have found that the refrigerants of the present invention, including each of Refrigerants 1-10 as described herein, are unexpectedly capable of providing a set of exceptionally advantageous properties including: excellent heat transfer properties (including high capacity relative (i.e., greater than 65% relative to HFC-134a), acceptable toxicity and nonflammability (i.e., is Class 1A), zero or near zero ozone depletion potential (“ODP”), relatively low evaporator glide, and lubricant compatibility, including miscibility with POE and/or PVE lubricants over the operating temperature and concentration ranges used in medium and low temperature refrigeration systems, cascade refrigeration systems, transport refrigeration systems, and heat pumps.

A particular advantage of the refrigerants of the present invention, including specifically each of Refrigerants 1-10, is that they are nonflammable and have acceptable toxicity, that is, each is a Class A1 refrigerant. It will be appreciated by the skilled person that the flammability of a refrigerant can be a characteristic that is given consideration in certain important heat transfer applications, and that refrigerants that are classified as Class A1 can frequently be an advantage over refrigerants that are not Class A1. Thus, it is a desire in the art to provide a refrigerant composition which can be used as a replacement for prior non-flammable refrigerants, such as R-22, R404A, R407F, R448A, R449A or R-134a which has excellent heat transfer properties, acceptable toxicity, zero or near zero ODP, and lubricant compatibility, including miscibility with POE and/or PVE lubricants over the operating temperature and concentration ranges used in medium and low temperature refrigeration systems, cascade refrigeration systems, transport refrigeration systems, and heat pumps (including residential air-to-water heat pump systems), and which maintains non-flammability in use. This desirable advantage can be achieved by the refrigerants of the present invention.

Applicants have found that the refrigerant compositions of the invention, including each of Refrigerants 1-10, are capable of achieving a difficult-to-achieve combination of properties including particularly low GWP. Thus, the compositions of the invention have a GWP of 150 or less.

In addition, the refrigerant compositions of the invention, including each of Refrigerants 1-10, have a zero or near zero ODP. Thus, the compositions of the invention have an ODP of not greater than 0.02, and more preferably zero.

In addition, the refrigerant compositions of the invention, including each of Refrigerants 1-10, show acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

The preferred refrigerant compositions of the invention show both acceptable toxicity and nonflammability under ASHRAE standard 34 and are therefore Class A1 refrigerants. Applicants have found that the heat transfer compositions of the present invention, including heat transfer compositions that include each of Refrigerants 1-10 as described herein, are capable of providing an exceptionally advantageous and unexpected combination of properties including: good heat transfer properties, chemical stability under the conditions of use, acceptable toxicity, nonflammability, zero or near zero ozone depletion potential (“ODP”), and lubricant compatibility, including miscibility with POE and/or PVE lubricants over the operating temperature and concentration ranges used in medium and low temperature refrigeration systems, cascade refrigeration systems, transport refrigeration systems, and heat pumps (including residential air-to-water heat pump systems.

The heat transfer compositions can consist essentially of any refrigerant of the present invention, including each of Refrigerants 1-10.

The refrigerants of the invention may be provided in a heat transfer composition. Thus, the heat transfer compositions of the present invention comprise a refrigerant of the present invention, including any of the preferred refrigerant compositions disclosed herein and in particular each of Refrigerants 1-10. Preferably, the invention relates to a heat transfer composition which comprises the refrigerant, including each of Refrigerants 1-10, in an amount of at least about 80% by weight of the heat transfer composition, or at least about 90% by weight of the heat transfer composition, or at least about 97% by weight of the heat transfer composition, or at least about 99% by weight of the heat transfer composition. The heat transfer composition may consist essentially of or consist of the refrigerant.

The heat transfer compositions of the present invention can consist of any refrigerant of the present invention, including each of Refrigerants 1-10.

The heat transfer compositions of the invention may include other components for the purpose of enhancing or providing certain functionality to the compositions. Such other components may include, in addition to the refrigerant of the present invention, including each of Refrigerants 1-10, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

Lubricants

The heat transfer compositions of the invention can comprise a refrigerant as described herein, including each of Refrigerants 1-10, and a lubricant. Heat transfer compositions as described in this paragraph are sometimes referred to for convenience as Heat Transfer Composition 1.

The heat transfer compositions of the invention can also comprise a refrigerant as described herein, including each of Refrigerants 1-10, and a polyol ester (POE) lubricant. Heat transfer compositions as described in this paragraph are sometimes referred to for convenience as Heat Transfer Composition 2.

The heat transfer compositions of the invention can also comprise a refrigerant as described herein, including each of Refrigerants 1-10, and a poly vinyl ether (PVE) lubricant. Heat transfer compositions as described in this paragraph are sometimes referred to for convenience as Heat Transfer Composition 3.

The heat transfer compositions of the invention can also comprise a refrigerant as described herein, including each of Refrigerants 1-10, and a polyol alkylene glycol (PAG) lubricant. Heat transfer compositions as described in this paragraph are sometimes referred to for convenience as Heat Transfer Composition 4.

Applicants have found that the heat transfer compositions of the present invention, including each of Heat Transfer Compositions 1-10 are capable of providing exceptionally advantageous properties including, in addition to the advantageous properties identified herein with respect to the refrigerant, excellent refrigerant/lubricant compatibility, including miscibility with POE and/or PVE and/or PAG lubricants, over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration).

A lubricant consisting essentially of a POE having a viscosity at 40° C. measured in accordance with ASTM D445 of from about 30 to about 70 is referred to herein as Lubricant 1.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| Property | RL32-3MAF | RL68H |
|---|---|---|
| Viscosity | about 31 | about 67 |
| @ 40° C. (ASTM D445), cSt | | |
| Viscosity | about 5.6 | about 9.4 |
| @ 100° C. (ASTM D445), cSt | | |
| Pour Point | about −40 | about −40 |
| (ASTM D97), ° C. | | |

A preferred heat transfer composition comprises a refrigerant of the present invention, including each of Refrigerants 1-10 and Lubricant 1. Heat transfer compositions as described in this paragraph are sometimes referred to for convenience as Heat Transfer Composition 5.

A lubricant consisting essentially of a POE having a viscosity at 40° C. measured in accordance with ASTM D445 of from about 30 to about 70 based on the weight of the heat transfer composition, is referred to herein as Lubricant 2.

Commercially available polyvinyl ethers that are preferred for use in the present heat transfer compositions that have a viscosity at 40° C. measured in accordance with ASTM D445 of from about 30 to about 70 include those lubricants sold under the trade designations FVC32D and FVC68D, from Idemitsu.

The lubricant of the present invention can include PVE lubricants generally. In preferred embodiments the PVE lubricant is as PVE according to Formula II below:

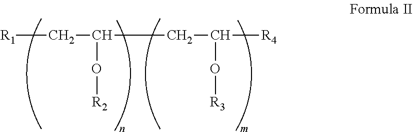

where R₂ and R₃ are each independently C1-C10 hydrocarbons, preferably C2-C8 hydrocarbons, and R₁ and R₄ are each independently alkyl, alkylene glycol, or polyoxyalkylene glycol units and n and m are selected preferably according to the needs of those skilled in the art to obtain a lubricant with the desired properties, and preferable n and m are selected to obtain a lubricant with a viscosity at 40° C. measured in accordance with ASTM D445 of from about 30 to about 70 cSt. A PVE lubricant according to the description immediately above is referred to for convenience as Lubricant 3. Commercially available polyvinyl ethers include those lubricants sold under the trade designations FVC32D and FVC68D, from Idemitsu.

A preferred heat transfer composition comprises a refrigerant of the present invention, including each of Refrigerants 1-10 and Lubricant 2. Heat transfer compositions as described in this paragraph are sometimes referred to for convenience as Heat Transfer Composition 6A.

A preferred heat transfer composition comprises a refrigerant of the present invention, including each of Refrigerants 1-10 and Lubricant 3. Heat transfer compositions as described in this paragraph are sometimes referred to for convenience as Heat Transfer Composition 6B.

The invention comprises includes heat transfer compositions of the present invention, including each of Heat Transfer Compositions 1-6, wherein the lubricant is present in the heat transfer composition in an amount of from about 0.1% by weight to about 5% by weight of the heat transfer composition. Heat transfer compositions as described in this paragraph are sometimes referred to for convenience as Heat Transfer Composition 7.

The invention comprises includes heat transfer compositions of the present invention, including each of Heat Transfer Compositions 1-6, wherein the lubricant is present in the heat transfer composition in an amount of from about 0.1% by weight to about 2% by weight of the heat transfer composition. Heat transfer compositions as described in this paragraph are sometimes referred to for convenience as Heat Transfer Composition 8.

The invention comprises includes heat transfer compositions of the present invention, including each of Heat Transfer Compositions 1-6, wherein the lubricant is present in the heat transfer composition in an amount of from about 0.1% by weight to about 1% by weight of the heat transfer composition. Heat transfer compositions as described in this paragraph are sometimes referred to for convenience as Heat Transfer Composition 9.

The invention comprises includes heat transfer compositions of the present invention, including each of Heat Transfer Compositions 1-6, wherein the lubricant is present in the heat transfer composition in an amount of from about 0.1% by weight to about 0.5% by weight of the heat transfer composition. Heat transfer compositions as described in this paragraph are sometimes referred to for convenience as Heat Transfer Composition 10.

The invention comprises includes heat transfer compositions of the present invention, including each of Heat Transfer Compositions 1-11, wherein the lubricant is present in the heat transfer composition in an amount of from about 0.2% by weight to about 0.5% by weight of the heat transfer composition. Heat transfer compositions as described in this paragraph are sometimes referred to for convenience as Heat Transfer Composition 11.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

Methods, Uses and Systems

Systems

The present invention includes heat transfer systems of all types that include refrigerants of the present invention, including each of Refrigerants 1-10, and/or that include heat transfer compositions of the invention, including each of Heat Transfer Compositions 1-11. Heat transfer systems as described in this paragraph are sometimes referred to for convenience as Heat Transfer System 1.

The present invention also includes, and provides particular advantage in connection with, low temperature refrigeration systems that include refrigerants of the present invention, including each of Refrigerants 1-10, and/or that include heat transfer compositions of the invention, including each of Heat Transfer Compositions 1-11. Heat transfer systems as described in this paragraph are sometimes referred to for convenience as Heat Transfer System 2.

The present invention also includes, and provides particular advantage in connection with, medium temperature refrigeration systems that include refrigerants of the present invention, including each of Refrigerants 1-10, and/or that include heat transfer compositions of the invention, including each of Heat Transfer Compositions 1-11. Heat transfer systems as described in this paragraph are sometimes referred to for convenience as Heat Transfer System 3.

The present invention also includes, and provides particular advantage in connection with, extreme temperature air conditioning systems that include refrigerants of the present invention, including each of Refrigerants 1-10, and/or that include heat transfer compositions of the invention, including each of Heat Transfer Compositions 1-11, and/or that operate in accordance with Heat Transfer Methods 1-3. Heat transfer systems as described in this paragraph are sometimes referred to for convenience as Heat Transfer System 4.

The present invention also includes, and provides particular advantage in connection with, high temperature heat pump systems that include refrigerants of the present invention, including each of Refrigerants 1-10, and/or that include heat transfer compositions of the invention, including each of Heat Transfer Compositions 1-11, and/or that operate in accordance with Heat Transfer Methods 1-3. Heat transfer systems as described in this paragraph are sometimes referred to for convenience as Heat Transfer System 5A.

The present invention also includes, and provides particular advantage in connection with, medium temperature refrigeration systems that include refrigerants of the present invention, including each of Refrigerants 1-10, and/or that include heat transfer compositions of the invention, including each of Heat Transfer Compositions 1-11. Heat transfer systems as described in this paragraph are sometimes referred to for convenience as Heat Transfer System 5B.

The present invention also includes and provides particular advantage in connection with cascade refrigeration systems that include refrigerants of the present invention, including each of Refrigerants 1-10, and/or that include heat transfer compositions of the invention, including each of Heat Transfer Compositions 1-11. Heat transfer systems as described in this paragraph are sometimes referred to for convenience as Heat Transfer System 6.

The present invention also provides basic cascade refrigeration systems that comprise:
(a) a low stage refrigeration circuit comprising:
   a low stage refrigerant having a GWP of about 150 or less; and
   a compressor;
(b) an inter-circuit heat exchanger in which said low stage refrigerant condenses; and
(c) a high stage refrigeration circuit comprising a high stage refrigerant evaporates in said inter-circuit heat exchanger by absorbing heat from said refrigerant in said low stage refrigeration circuit.

The table below defines a series of cascade refrigeration systems of the present invention which include the elements of this paragraph and in addition requires the elements or limitations thereof as specified in the table below, with each such system being defined as a Cascade System (CS) of the present invention by the CS number/letter in column 1 of the table below, it being understood that all values are understood to be preceded by the word “about” unless otherwise indicated in the table. In the table below it also understood that unless a “Refrigerant Component” is specifically indicated in the table to be “consisting essentially of” or “consisting of,” then refrigerant comprises the refrigerant component as indicated. Similarly, it also understood that unless the “Refrigerant” under the broad heading “Low Stage Requirements” is specifically indicated in the table to be “consisting essentially of” or “consisting of,” then the low stage comprises the indicated refrigerant. The designation “NR” is understood to mean that the component or property is not required (but may be present) and that the designation “NL” means that the property of feature is not limited by the definition in the table.

CASCADE SYSTEMS

| | High Stage Requirements | | | | | | | | |
|---|---|---|---|---|---|---|---|---|---|
| | Refrigerant | | | Refrigerant Properties | | | | | |
| | Components, wt% | | | | | Evap. | | | |
| | 1234ze | | 1224 | | | Glide, | Low Stage Requirements | | |
| | (E) | 134a | yd(Z) | GWP | Flam | ° C. | Refrigerant | GWP | Flam |
| CS1 | =>75 | NR | NR | NL | A1 or | NR | NL | =<150 | NL |
| | | | | | A2L | | | | |
| CS1B | =>74 | NR | NR | NL | A1 | NR | NL | =<150 | A1 or A2L |
| CS1C | =>74 | 5-< | NR | NL | A1 | NR | NL | =<150 | A1 or A2L |
| | | 12 | | | | | | | |
| CS2A | =>74 | 5-< | NR | NL | A1 | NR | Consists | NL | NL |
| | | 12 | | | | | essentially | | |
| | | | | | | | of CO₂ | | |
| CS2B | =>74 | 5-< | NR | NL | A1 | NR | Consists | NL | NL |
| | | 12 | | | | | essentially | | |
| | | | | | | | of propane | | |
| CS2C | =>74 | 5-< | NR | NL | A1 | NR | Consists | NL | NL |
| | | 12 | | | | | essentially | | |
| | | | | | | | of 1234yf | | |
| CS2D | =>74 | 5-< | NR | NL | A1 | NR | Consists | NL | NL |
| | | 12 | | | | | essentially | | |
| | | | | | | | of R454C | | |
| CS2E | =>74 | 5-< | NR | NL | A1 | NR | Consists | NL | NL |
| | | 12 | | | | | essentially | | |
| | | | | | | | of R455A | | |
| CS3A | 76-80 | 10- | 5-< | NL | A1 | NL | Consists | NL | NL |
| | | 15 | 11 | | | | essentially | | |
| | | | | | | | of CO₂ | | |
| CS3B | 76-80 | 10- | 5-< | NL | A1 | NL | Consists | NL | NL |
| | | 15 | 11 | | | | essentially | | |
| | | | | | | | of propane | | |
| CS3C | 76-80 | 10- | 5-< | NL | A1 | NL | Consists | NL | NL |
| | | 15 | 11 | | | | essentially | | |
| | | | | | | | of 1234yf | | |
| CS3D | 76-80 | 10- | 5-< | NL | A1 | NL | Consists | NL | NL |
| | | 15 | 11 | | | | essentially | | |
| | | | | | | | of 454C | | |
| CS3E | 76-80 | 10- | 5-< | NL | A1 | NL | Consists | NL | NL |
| | | 15 | 11 | | | | essentially | | |
| | | | | | | | of R455A | | |
| CS4A | 77 | 13 | =<13 | NL | A1 | NL | Consists | NL | NL |
| | | | | | | | essentially | | |
| | | | | | | | of CO₂ | | |
| CS4B | 77 | 13 | =<13 | NL | A1 | NL | Consists | NL | NL |
| | | | | | | | essentially | | |
| | | | | | | | of propane | | |
| CS4C | 77 | 13 | =<13 | NL | A1 | NL | Consists | NL | NL |
| | | | | | | | essentially | | |
| | | | | | | | of 1234yf | | |
| CS4D | 77 | 13 | =<13 | NL | A1 | NL | Consists | NL | NL |
| | | | | | | | essentially | | |
| | | | | | | | of 454C | | |
| CS4D | 77 | 13 | =<13 | NL | A1 | NL | Consists | NL | NL |
| | | | | | | | essentially | | |
| | | | | | | | of 455A | | |
| CS5A | Refrigerant 1 | | | NL | NL | NL | NL | NL | NL |
| CS5B | Refrigerant 2 | | | NL | NL | NL | NL | NL | NL |
| CS5C | Refrigerant 3 | | | NL | NL | NL | NL | NL | NL |
| CS5D | Refrigerant 4 | | | NL | NL | NL | NL | NL | NL |
| CS5E | Refrigerant 5 | | | NL | NL | NL | NL | NL | NL |
| CS5F | Refrigerant 6 | | | NL | NL | NL | NL | NL | NL |
| CS5G | Refrigerant 7 | | | NL | NL | NL | NL | NL | NL |
| CS5H | Refrigerant 8A | | | NL | NL | NL | NL | NL | NL |
| CS51 | Refrigerant 8B | | | NL | NL | NL | NL | NL | NL |
| CS5J | Refrigerant 8C | | | NL | NL | NL | NL | NL | NL |
| CS5K | Refrigerant 9 | | | NL | NL | NL | NL | NL | NL |
| CS5L | Refrigerant 10 | | | NL | NL | NL | NL | NL | NL |
| CS6A | Refrigerant 1 | | | NL | NL | NL | propane | NL | NL |
| CS6B | Refrigerant 2 | | | NL | NL | NL | propane | NL | NL |
| CS6C | Refrigerant 3 | | | NL | NL | NL | propane | NL | NL |
| CS6D | Refrigerant 4 | | | NL | NL | NL | propane | NL | NL |
| CS6E | Refrigerant 5 | | | NL | NL | NL | propane | NL | NL |
| CS6F | Refrigerant 6 | | | NL | NL | NL | propane | NL | NL |
| CS6G | Refrigerant 7 | | | NL | NL | NL | propane | NL | NL |
| CS6H | Refrigerant 8A | | | NL | NL | NL | propane | NL | NL |
| CS61 | Refrigerant 8B | | | NL | NL | NL | propane | NL | NL |
| CS6J | Refrigerant 8C | | | NL | NL | NL | propane | NL | NL |
| CS6K | Refrigerant 9 | | | NL | NL | NL | propane | NL | NL |
| CS6L | Refrigerant 10 | | | NL | NL | NL | propane | NL | NL |
| CS7A | Refrigerant 1 | | | NL | NL | NL | 1234yf | NL | NL |
| CS7B | Refrigerant 2 | | | NL | NL | NL | 1234yf | NL | NL |
| CS7C | Refrigerant 3 | | | NL | NL | NL | 1234yf | NL | NL |
| CS7D | Refrigerant 4 | | | NL | NL | NL | 1234yf | NL | NL |
| CS7E | Refrigerant 5 | | | NL | NL | NL | 1234yf | NL | NL |
| CS7F | Refrigerant 6 | | | NL | NL | NL | 1234yf | NL | NL |
| CS7G | Refrigerant 7 | | | NL | NL | NL | 1234yf | NL | NL |
| CS7H | Refrigerant 8A | | | NL | NL | NL | 1234yf | NL | NL |
| CS71 | Refrigerant 8B | | | NL | NL | NL | 1234yf | NL | NL |
| CS7J | Refrigerant 8C | | | NL | NL | NL | 1234yf | NL | NL |
| CS7K | Refrigerant 9 | | | NL | NL | NL | 1234yf | NL | NL |
| CS7L | Refrigerant 10 | | | NL | NL | NL | 1234yf | NL | NL |
| CS8A | Refrigerant 1 | | | NL | NL | NL | R454C | NL | NL |
| CS8B | Refrigerant 2 | | | NL | NL | NL | R454C | NL | NL |
| CS8C | Refrigerant 3 | | | NL | NL | NL | R454C | NL | NL |
| CS8D | Refrigerant 4 | | | NL | NL | NL | R454C | NL | NL |
| CS8E | Refrigerant 5 | | | NL | NL | NL | R454C | NL | NL |
| CS8F | Refrigerant 6 | | | NL | NL | NL | R454C | NL | NL |
| CS8G | Refrigerant 7 | | | NL | NL | NL | R454C | NL | NL |
| CS8H | Refrigerant 8A | | | NL | NL | NL | R454C | NL | NL |
| CS81 | Refrigerant 8B | | | NL | NL | NL | R454C | NL | NL |
| CS8J | Refrigerant 8C | | | NL | NL | NL | R454C | NL | NL |
| CS8K | Refrigerant 9 | | | NL | NL | NL | R454C | NL | NL |
| CS8L | Refrigerant 10 | | | NL | NL | NL | R454C | NL | NL |
| CS9A | Refrigerant 1 | | | NL | NL | NL | R455A | NL | NL |
| CS9B | Refrigerant 2 | | | NL | NL | NL | R455A | NL | NL |
| CS9C | Refrigerant 3 | | | NL | NL | NL | R455A | NL | NL |
| CS9D | Refrigerant 4 | | | NL | NL | NL | R455A | NL | NL |
| CS9E | Refrigerant 5 | | | NL | NL | NL | R455A | NL | NL |
| CS9F | Refrigerant 6 | | | NL | NL | NL | R455A | NL | NL |
| CS9G | Refrigerant 7 | | | NL | NL | NL | R455A | NL | NL |
| CS9H | Refrigerant 8A | | | NL | NL | NL | R455A | NL | NL |
| CS91 | Refrigerant 8B | | | NL | NL | NL | R455A | NL | NL |
| CS9J | Refrigerant 8C | | | NL | NL | NL | R455A | NL | NL |
| CS9K | Refrigerant 9 | | | NL | NL | NL | R455A | NL | NL |
| CS9L | Refrigerant 10 | | | NL | NL | NL | R455A | NL | NL |
| CS10 | =>74 | 5-< | NR | <150 | A1 | <4.5° C. | Consists | NL | NL |
| A | | 12 | | | | | essentially | | |
| | | | | | | | of CO₂ | | |
| CS10 | =>74 | 5-< | NR | <150 | A1 | <4.5° C. | Consists | NL | NL |
| B | | 12 | | | | | essentially | | |
| | | | | | | | of propane | | |
| CS10 | =>74 | 5-< | NR | <150 | A1 | <4.5° C. | Consists | NL | NL |
| C | | 12 | | | | | essentially | | |
| | | | | | | | of 1234yf | | |
| CS10 | =>74 | 5-< | NR | <150 | A1 | <4.5º° C. | Consists | NL | NL |
| D | | 12 | | | | | essentially | | |
| | | | | | | | of R454C | | |
| CS10 | =>74 | 5-< | NR | <150 | A1 | <4.5° C. | Consists | NL | NL |
| E | | 12 | | | | | essentially | | |
| | | | | | | | of R455A | | |
| CS11 | 76-80 | 10- | 5-< | <150 | A1 | <4.5° C. | CO₂ | =<150 | A1 or A2L |
| A | | 15 | 11 | | | | | | |
| CS11 | 76-80 | 10- | 5-< | <150 | A1 | <4.5° C. | propane | =<150 | A1 or A2L |
| B | | 15 | 11 | | | | | | |
| CS11 | 76-80 | 10- | 5-< | <150 | A1 | <4.5° C. | 1234yf | =<150 | A1 or A2L |
| C | | 15 | 11 | | | | | | |
| CS11 | 76-80 | 10- | 5-< | <150 | A1 | <4.5° C. | 454C | =<150 | A1 or A2L |
| D | | 15 | 11 | | | | | | |
| CS11 | 76-80 | 10- | 5-< | <150 | A1 | <4.5° C. | R455A | =<150 | A1 or A2L |
| E | | 15 | 11 | | | | | | |
| CS12 | 77 | 13 | =<13 | NL | A1 | <4.5° C. | CO₂ | =<150 | A1 or A2L |
| A | | | | | | | | | |
| CS12 | 77 | 13 | =<13 | NL | A1 | <4.5° C. | propane | =<150 | A1 or A2L |
| B | | | | | | | | | |
| CS12 | 77 | 13 | =<13 | NL | A1 | <4.5° C. | 1234yf | =<150 | A1 or A2L |
| C | | | | | | | | | |
| CS12 | 77 | 13 | =<13 | NL | A1 | <4.5° C. | 454C | =<150 | A1 or A2L |
| D | | | | | | | | | |
| CS12 | 77 | 13 | =<13 | NL | A1 | <4.5° C. | 455A | =<150 | A1 or A2L |
| E | | | | | | | | | |

The present invention includes a cascade refrigeration system, including each of Cascade Systems 1 through 12 in the table above, wherein said low stage refrigerant condenses in said inter-circuit heat exchanger within the range of temperatures of from about −5° C. to about −15° C. For the purposes of convenience, systems in accordance with this paragraph are sometimes referred to herein as Cascade System 13.

The present invention includes a cascade refrigeration system, including each of Cascade Systems 1 through 12 in the table above, wherein said high stage refrigerant evaporates in said inter-circuit heat exchanger within the range of temperatures of from about −5° C. to about −15° C. For the purposes of convenience, systems in accordance with this paragraph are sometimes referred to herein as Cascade System 14.

The present invention includes a cascade refrigeration system, including each of Cascade Systems 1 through 12 in the table above and Cascade Systems 13 and 14, wherein said low stage refrigeration circuit comprises a plurality of low stage refrigeration circuits. For the purposes of convenience, systems in accordance with this paragraph are sometimes referred to herein as Cascade System 15.

The present invention includes a cascade refrigeration system, including each of Cascade Systems 1 through 12 in the table above and Cascade Systems 13-15, wherein said low stage refrigeration circuit is located in an area open to the public. For the purposes of convenience, systems in accordance with this paragraph are sometimes referred to herein as Cascade System 16.

The present invention includes a cascade refrigeration system, including each of Cascade Systems 1 through 12 in the table above and Cascade Systems 13-16, wherein said low stage refrigeration circuits comprises a plurality of self-contained low stage refrigeration circuits, with at least two of such low stage circuits being contained in a separate, modular refrigeration unit and each of said modular refrigeration units being located in a first area open to the public. For the purposes of convenience, systems in accordance with this paragraph are sometimes referred to herein as System 17.

The present invention includes a cascade refrigeration system, including each of Cascade Systems 1 through 12 in the table above and Cascade Systems 13-17, wherein said compressor in each of said low stages has a horsepower rating of about 2 horsepower or less. For the purposes of convenience, systems in accordance with this paragraph are sometimes referred to herein as Cascade System 18.

The present invention includes a cascade refrigeration system, including each of Cascade Systems 1 through 12 in the table above and Cascade Systems 13-18, wherein said low stage comprises a low temperature refrigeration circuit. For the purposes of convenience, systems in accordance with this paragraph are sometimes referred to herein as Cascade System 19.

The present invention includes a cascade refrigeration system, including each of Cascade Systems 1 through 12 in the table above and Cascade Systems 13-19, wherein said high stage comprises a medium temperature refrigeration circuit. For the purposes of convenience, systems in accordance with this paragraph are sometimes referred to herein as Cascade System 20.

The present invention includes a cascade refrigeration system, including each of Cascade Systems 1 through 12 in the table above and Cascade Systems 13-20, wherein said system comprises a commercial refrigeration system. For the purposes of convenience, systems in accordance with this paragraph are sometimes referred to herein as Cascade System 21.

The present invention also includes, and provides particular advantage in connection with, chillers (including air-cooled chillers) that include refrigerants of the present invention, including each of Refrigerants 1-10, and/or that include heat transfer compositions of the invention, including each of Heat Transfer Compositions 1-11 and/or that comprise cascade refrigeration systems of the present invention, including each of Cascade Systems 1-21. Heat transfer systems as described in this paragraph are sometimes referred to for convenience as Heat Transfer System 7.

The present invention also includes, and provides particular advantage in connection with, heat pump systems that include refrigerants of the present invention, including each of Refrigerants 1-10, and/or that include heat transfer compositions of the invention, including each of Heat Transfer Compositions 1-11 and/or that comprise cascade refrigeration systems of the present invention, including each of Cascade Systems 1-21. Heat transfer systems as described in this paragraph are sometimes referred to for convenience as Heat Transfer System 8.

The present invention also includes, and provides particular advantage in connection with, commercial refrigeration (including low temperature commercial refrigeration and medium temperature commercial refrigeration) that include refrigerants of the present invention, including each of Refrigerants 1-10, and/or that include heat transfer compositions of the invention, including each of Heat Transfer Compositions 1-11 and/or that comprise cascade refrigeration systems of the present invention, including each of Cascade Systems 1-21. Heat transfer systems as described in this paragraph are sometimes referred to for convenience as Heat Transfer System 9.

For heat transfer systems of the present invention that include a compressor and lubricant for the compressor in the system, the system can comprise a loading of refrigerant of the present invention, including each of Refrigerants 1-10, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

In particular aspects, heat transfer compositions of the invention comprise any one of Refrigerants 1 to 10 and lubricant in a low temperature refrigeration system as follows:

| REFRIGERANT | LUBRICANT | REFRIGERATION SYSTEM |
|---|---|---|
| Refrigerant 1 | POE or PVE | low temperature refrigeration |
| Refrigerant 2 | POE or PVE | low temperature refrigeration |
| Refrigerant 3 | POE or PVE | low temperature refrigeration |
| Refrigerant 4 | POE or PVE | low temperature refrigeration |
| Refrigerant 5 | POE or PVE | low temperature refrigeration |
| Refrigerant 6 | POE or PVE | low temperature refrigeration |
| Refrigerant 7 | POE or PVE | low temperature refrigeration |
| Refrigerant 8 | POE or PVE | low temperature refrigeration |
| Refrigerant 9 | POE or PVE | low temperature refrigeration |
| Refrigerant 10 | POE or PVE | low temperature refrigeration |

Heat transfer compositions comprise any one of Refrigerants 1 to 10 and lubricant in a medium temperature refrigeration system as follows:

| REFRIGERANT | LUBRICANT | REFRIGERATION SYSTEM |
|---|---|---|
| Refrigerant 1 | POE or PVE | medium temperature refrigeration |
| Refrigerant 2 | POE or PVE | medium temperature refrigeration |
| Refrigerant 3 | POE or PVE | medium temperature refrigeration |
| Refrigerant 4 | POE or PVE | medium temperature refrigeration |
| Refrigerant 5 | POE or PVE | medium temperature refrigeration |
| Refrigerant 6 | POE or PVE | medium temperature refrigeration |
| Refrigerant 7 | POE or PVE | medium temperature refrigeration |
| Refrigerant 8 | POE or PVE | medium temperature refrigeration |
| Refrigerant 9 | POE or PVE | medium temperature refrigeration |
| Refrigerant 10 | POE or PVE | medium temperature refrigeration |
| Refrigerant 11 | POE or PVE | medium temperature refrigeration |

Heat transfer compositions comprise any one of Refrigerants 1 to 10 and lubricant in a retail food refrigeration system as follows:

| REFRIGERANT | LUBRICANT | REFRIGERATION SYSTEM |
|---|---|---|
| Refrigerant 1 | POE or PVE | Retail food refrigeration |
| Refrigerant 2 | POE or PVE | Retail food refrigeration |
| Refrigerant 3 | POE or PVE | Retail food refrigeration |
| Refrigerant 4 | POE or PVE | Retail food refrigeration |
| Refrigerant 5 | POE or PVE | Retail food refrigeration |
| Refrigerant 6 | POE or PVE | Retail food refrigeration |
| Refrigerant 7 | POE or PVE | Retail food refrigeration |
| Refrigerant 8 | POE or PVE | Retail food refrigeration |
| Refrigerant 9 | POE or PVE | Retail food refrigeration |
| Refrigerant 10 | POE or PVE | Retail food refrigeration |

Heat transfer compositions comprise any one of Refrigerants 1 to 10 and lubricant in a transport refrigeration system as follows:

| REFRIGERANT | LUBRICANT | REFRIGERATION SYSTEM |
|---|---|---|
| Refrigerant 1 | POE or PVE | Transport refrigeration |
| Refrigerant 2 | POE or PVE | Transport refrigeration |
| Refrigerant 3 | POE or PVE | Transport refrigeration |
| Refrigerant 4 | POE or PVE | Transport refrigeration |
| Refrigerant 5 | POE or PVE | Transport refrigeration |
| Refrigerant 6 | POE or PVE | Transport refrigeration |
| Refrigerant 7 | POE or PVE | Transport refrigeration |
| Refrigerant 8 | POE or PVE | Transport refrigeration |
| Refrigerant 9 | POE or PVE | Transport refrigeration |
| Refrigerant 10 | POE or PVE | Transport refrigeration |

### Exemplary Heat Transfer Systems

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature and pressure, which in turn is then provided to evaporator 50. In evaporator 50 the liquid refrigerant absorbs heat from the body or fluid being cooled, thus producing a refrigerant vapor which is then provided to the suction line of the compressor.

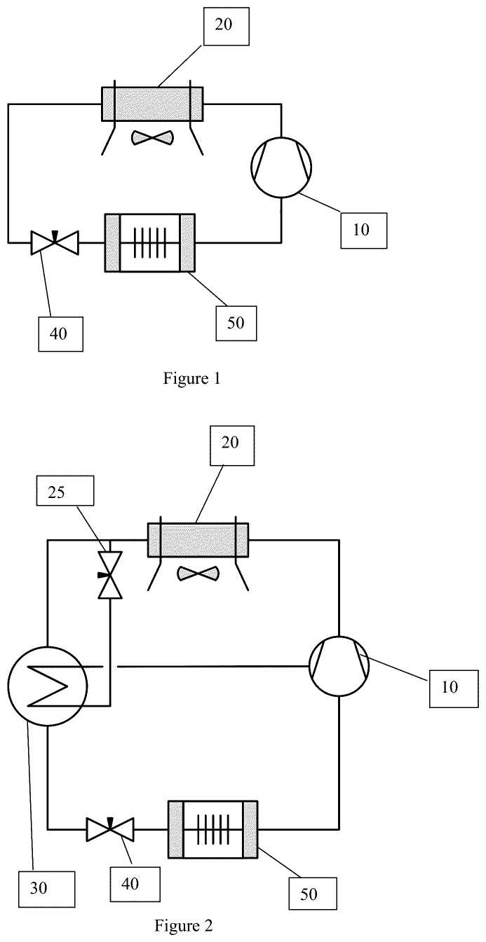

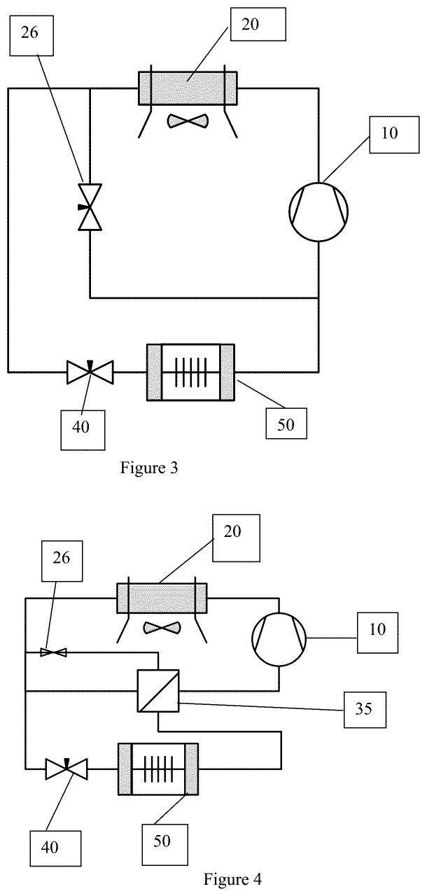

The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

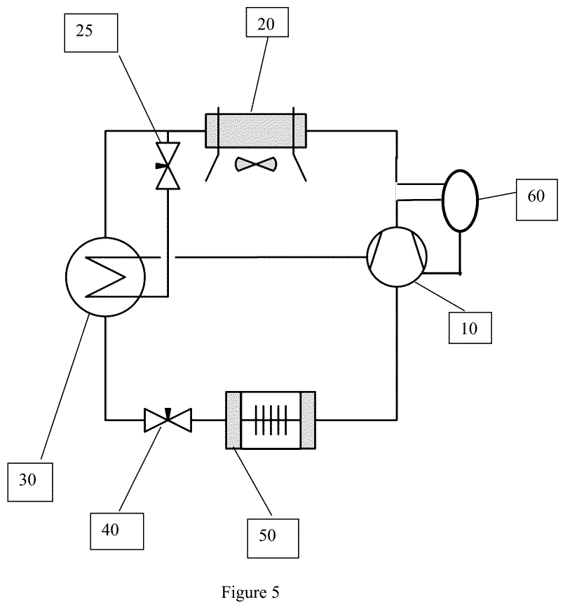

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

The refrigeration system illustrated in FIG. 4 is the same as described above in connection with FIG. 1 except that it includes a liquid line/suction line heat exchanger 35. The valve 25 diverts a portion, and optionally all, of the of the refrigerant flow from the condenser outlet to the liquid line/suction line heat exchanger 35, where heat is transferred from the liquid refrigerant to the refrigerant vapor leaving evaporator 50, and the further cooled liquid refrigerant leaving the heat exchanger 35 is directed to expansion device 40 and evaporator 50.

The refrigeration system illustrated in FIG. 5 is the same as described above in connection with FIG. 1 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

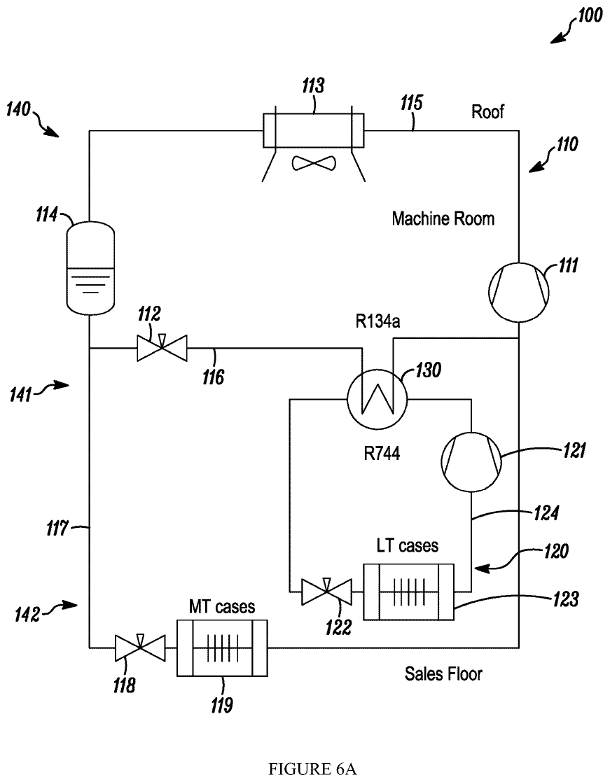

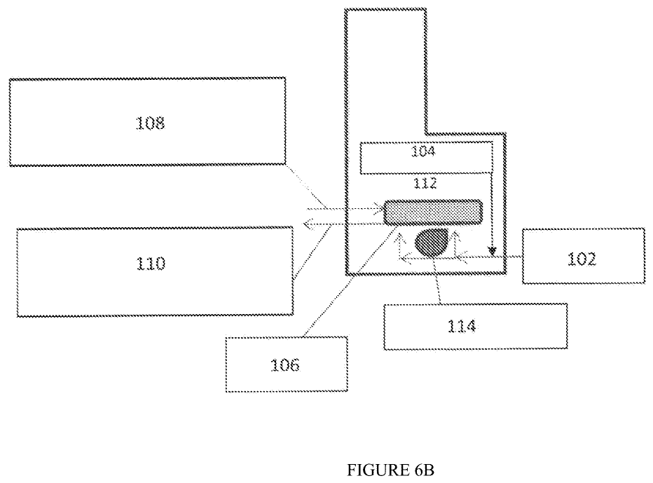

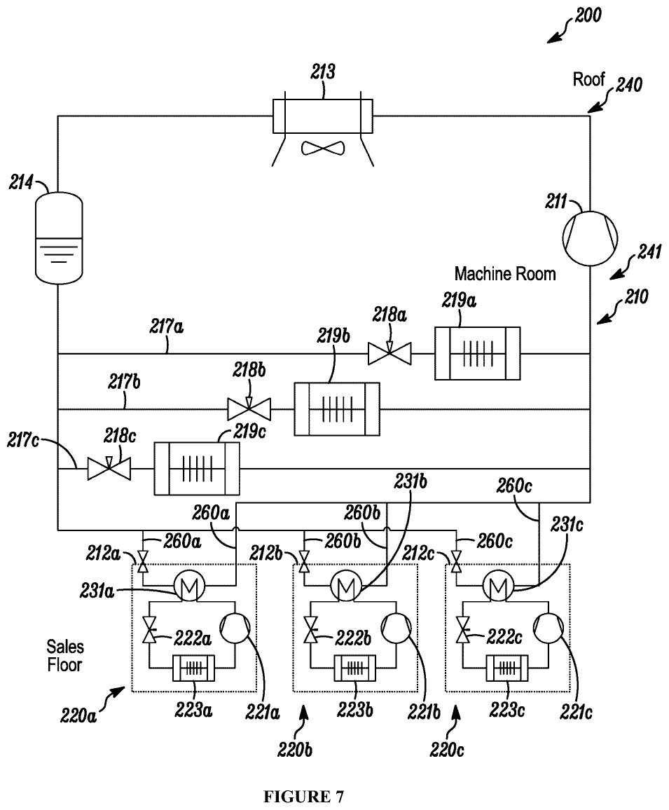

It will be appreciated by those skilled in the art that the different equipment/configuration options shown separately in each of FIGS. 2-5 can be combined and used together as deemed advantageous for any application, including in cascade refrigeration systems, preferred embodiments of which are described above in connection with FIGS. 6A and 6B and hereinafter in connection with FIGS. 7-9.

### Cascade Systems

The present invention also includes a cascaded refrigeration system, including each of the Cascade Systems 1-21, in which said heat exchanger (iii) is a heat exchanger in which said high stage refrigerant evaporates in said heat exchanger by absorbing heat from said low stage.

The present invention also includes a cascade refrigeration system, including each of Cascade Systems 1-21, comprising: a plurality of low temperature refrigeration circuits, with each low temperature refrigeration circuit comprising a flammable low temperature refrigerant comprising at least about 50% by weight, or at least about 75% by weight, or at least 95% by weight, or at least 99% by weight of HFO-1234yf, R454C, R455A, propane or combinations of these. As used herein, reference to a numbered system or group of numbered systems that have been defined herein means each such numbered systems, including each system having a number within the group, including any suffixed numbered system. For example, reference to Cascade System 1 includes reference to each of Cascade Systems 1A, 1B and 1C.

The present invention also includes a cascaded refrigeration system, including each of the Cascade Systems 1-21, comprising: a plurality of low temperature refrigeration circuits, with each low temperature refrigeration circuit comprising a flammable low temperature refrigerant comprising at least about 75% by weight, or at least 95% by weight, or at least 99% by weight of HFO-1234yf, wherein said heat exchanger is a heat exchanger in which said medium temperature refrigerant evaporates in said heat exchanger by absorbing heat from said low temperature refrigerant.

As used herein, the term “low temperature refrigeration unit” means an at least partially closed or closable structure that is capable of providing cooling within at least a portion of that structure and which is structurally distinct from any structure enclosing or containing the high stage refrigeration circuit. According to and consistent with such meanings, the preferred low stage refrigeration circuits, and low temperature refrigeration circuit, are sometimes referred to herein as “self-contained” when contained within such first (preferably low temperature) refrigeration units, in accordance with the meanings described herein.

In preferred embodiments, each low stage refrigeration unit, including such units corresponding to the low stage in each of Cascade Systems 1-21, may be located within a first area. The first area may be a shop floor. This means that each first refrigeration circuit (preferably low temperature refrigeration circuit) may also be located within a first area, such as a shop or supermarket floor accessible to the public.

Each refrigeration unit including in each of Cascade Systems 1-11, may comprise a space and/or objects contained within a space to be chilled, and preferably that space is within the refrigeration unit. Each evaporator may be located to chill its respective space/objects, preferably by cooling air within the space to be chilled.

As mentioned above, the high stage refrigeration circuit of the present invention, including the high stage in each of Cascade Systems 1-11, may have components thereof that extend between the low stage refrigeration unit (preferably low temperature refrigeration unit) and a second area. The second area may be, for example, a machine room which houses a substantial portion of the components of the high stage refrigeration circuit.

The high stage refrigeration circuit of the preset invention, including in each of Cascade Systems 1-21, may extend to a second and a third area. The third area may be an area outside of the building or buildings in which the first refrigeration units and the second area(s) are located. This allows for ambient cooling to be exploited.

Unless otherwise indicated herein for a particular embodiment, the refrigerant in each of the low stage refrigeration circuits may be different from or the same as the other refrigerants in the low stage refrigeration circuits, and each may also be the same or different to the refrigerant in the high stage refrigeration circuit.

The high stage refrigeration circuit may be quite long and may extend between different areas of a building: for example, between a shop floor (where refrigeration units might be deployed) to a machine room. Consequently, it may be unsafe to have a flammable refrigerant in the high stage refrigeration circuit since both the risk of leaks and the severity of potential leaks is increased as, in such embodiments, the high stage refrigeration circuit spans a greater area and therefore exposes more people and/or structures to risk of fire.

Each low stage refrigeration circuit, including in each of Cascade Systems 1-21, may comprise at least one fluid expansion device. The at least one fluid expansion device may be a capillary tube or an orifice tube. This is enabled by the conditions imposed on each first refrigeration circuit by its respective refrigeration unit being relatively constant. This means that simpler flow control devices, such as capillary and orifice tubes, can be and preferably are used to advantage in the first refrigeration circuits.

The high stage refrigeration circuit, including in each of Cascade Systems 1-21, may comprise a second evaporator. The second evaporator may be coupled in parallel with the circuit interface locations.

One embodiment of a cascade refrigeration system according to the present invention is illustrated schematically in FIG. 7 and described in detail below.

FIG. 7 shows a cascade refrigeration system 200. More specifically, FIG. 7 shows a refrigeration system 200 which has three low stage refrigeration circuits 220a, 220b and 220c. Each of the low stage refrigeration circuits 220a, 220b, 220c has an evaporator 223, a compressor 221, a heat exchanger 230 and an expansion valve 222. While each of the compressors, evaporators and heat exchangers in the circuit are illustrated by a single icon, it will be appreciated that the compressor, the evaporator, the heat exchanger, expansion valve, etc. can each comprise a plurality of such units. In each circuit 220a, 220b and 220c, the evaporator 223, the compressor 221, the heat exchanger 230 and the expansion valve 222 are connected in series with one another in the order listed. Each of the low stage refrigeration circuits 220a, 220b and 220c is included within a separate respective refrigeration unit (not shown). In this example, each of the three refrigeration units is preferably a freezer unit and the freezer unit houses a respective low temperature refrigeration circuit. In this way, each refrigeration unit comprises a self-contained and dedicated low temperature refrigeration circuit. The refrigeration units (not shown), and therefore the low temperature refrigeration circuits 220a, 220b, 220c, may be arranged, for example, arranged on a sales floor 242 of a supermarket.

In this example, the refrigerant in each of the low stage refrigeration circuits 220a, 220b, 220c is a low GWP refrigerant such as CO2, propane, HFO-1234yf, R454C, R455A or a combination of two or more of these. As the skilled person will appreciate, the refrigerants in each of the low stage circuits 220a, 220b,220c may the same or different to the refrigerants in each other of the low stage refrigeration circuits 220a, 220b, 220c, but in a preferred embodiment each of the plurality of low stage circuits contains CO2, propane, HFO-1234yf, R454C, R455A or a combination of two or more of these.

The refrigeration system 200 also has a high stage refrigeration circuit 210. The high stage circuit 210 has a compressor 211, a condenser 213 and a fluid receiver 214. The compressor 211, the condenser 213 and the fluid receiver 214 are connected in series and in the order given. While each of the compressors, condensers, fluid receivers, etc. in the high stage circuit are illustrated by a single icon, it will be appreciated that the compressor, the evaporator, the heat exchanger, expansion valve, etc. can each comprise a plurality of such units. The high stage refrigeration circuit 210 also has four parallel connected branches: three medium temperature cooling branches 217a, 217b and 217c, which are not in heat transfer communication with the low stage; and low stage cooling branch 216. The four parallel connected branches 217a, 217b, 217c and 216 are connected between the fluid receiver 214 and the compressor 211. Each of the medium temperature cooling branches 217a, 217b and 217c has an expansion valve 218a, 218b and 218c and an evaporator 219a, 219b and 219c, respectively. The expansion valve 218 and evaporator 219 are connected in series and in the order given between the fluid receiver 214 and the condenser 211. The high stage circuit 220, which in preferred embodiments comprises a low temperature cooling branch, 216 has an expansion valve 212 and an interface, in the form of inlet and outlet piping, conduits, valves and the like (represented collectively as 260a, 260b and 260c, respectively) which bring the high stage refrigerant liquid to and high stage refrigerant vapor from each of the inter-circuit heat exchangers 230a, 230b, 230c, which as shown in a preferred embodiment are located within the refrigeration unit 220. The low temperature cooling branch 216 interfaces each of the inter-circuit heat exchangers 230a, 230b, 230c at a respective circuit interface location 231a, 231b, 231c. Each circuit interface location 231a, 231b, 231c is arranged in series-parallel combination with each other of the circuit interface locations 231a, 231b, 231c.

The high stage refrigeration circuit 210 has components which extend between the sales floor 242, a machine room 241 and a roof 140. The cooling branch 216 and the medium temperature branches 218a, 218b, 218c of the medium temperature refrigeration circuit 210 are preferably located on the sales floor 242. The compressor 211 and the fluid receiver 214 are preferably located in the machine room 241. The condenser 213 is preferably located where it can be readily exposed to ambient conditions, such as on the roof 240.

In this example, the refrigerant in the high stage refrigeration circuit 210 comprises, consists essentially of, or consists of a refrigerant that comprises at least about 74% by weight of HFO-1234ze and has a Class 1A or A2L flammability. The present invention includes cascade systems in which the refrigerant in the high stage refrigeration circuit 210 comprises, consists essentially of, or consists of HFO-1234ze(E), HDR165 and/or HDR166. Further advantageously, the blend has a low GWP, making it an environmentally friendly solution, as well as excellent heat transfer performance properties, as illustrated below in the Examples hereof.

Use of the preferred embodiments as illustrated in FIG. 7 can be summarized as follows:
each of the low stage refrigeration circuits 220a, 220b, 220c absorbs heat via their evaporators 223 to provide low temperature cooling to a space to be chilled (not shown);
the high stage refrigeration circuit 210, via branch 216, absorbs heat from each of the inter-circuit heat exchangers 230a, 230b, 230c to cool the condense the low stage refrigerant vapor from the respective compressors in each of low stage circuits 220a, 220b, 220c;
the high stage refrigeration circuit 210 absorbs heat at each of the evaporators 219 to provide medium temperature cooling to spaces to be chilled (not shown); and
heat is removed from the refrigerant in the high stage refrigeration circuit 210 in the air-cooled chiller 213.

A number of beneficial results can be achieved using arrangements of the present invention of the type shown in FIG. 7, particularly from each refrigeration circuit 230 being self-contained in a respective refrigeration unit. For example, installation and uninstallation of the refrigeration units and the overall cascaded refrigeration system 200 is simplified. This is because the refrigeration units, with their built-in, self-contained refrigeration circuits 220a, 220b, 220c, can be easily connected or disconnected with the high stage refrigeration circuit 210, with no modification to the refrigeration circuit 220, 220b, 220c required. In other words, the refrigeration units may simply be ‘plugged’ in to, or out of, the high stage refrigeration circuit 210.

Another advantage is that each refrigeration unit, including its respective first refrigeration circuit 220a, 220b, 220c, can be factory tested for defaults before being installed into a live refrigeration system 200. This mitigates the likelihood of faults, which can include leaks of potentially harmful refrigerants. Accordingly, reduced leak rate can be achieved.

Another advantage in preferred embodiments is the provision of an inter-circuit heat exchanger which in systems of the present invention, including each of Cascade Systems 1-21, resulting in improved heat transfer between the low stage and the high stage. Accordingly, the efficiency of the overall refrigeration system is improved.

In preferred embodiments, including each of Cascade Systems 1-21, the present invention also includes a cascaded refrigeration system, comprising: a plurality of low temperature refrigeration circuits, with each low temperature refrigeration circuit comprising a low temperature refrigerant having a GWP of about 150 or less and comprising at least about 75% by weight by weight of R1234yf, including specifically R-454C and/or R455A, and a compressor having a work output of about 3.5 kilowatts or less, an inter-circuit heat exchanger in which said low temperature refrigerant condenses in the range of temperatures of from about −5° C. to about −15° C.; and a medium temperature refrigeration circuit containing medium temperature refrigerant, wherein said medium temperature refrigerant comprises, consists essentially of, or consists of at least about 74% by weight of HFO-1234ze(E), including particularly HDR165 and/or HDR166, and an evaporator in which said medium temperature refrigerant evaporates at a temperature below said low temperature refrigerant condensing temperature and in the range of about −5° C. to about −15° C., wherein said medium temperature refrigerant evaporates in said heat exchanger by absorbing heat from said low temperature refrigerant.

In preferred embodiments, including each of Cascade Systems 1-21, the present invention also includes a cascaded refrigeration system, comprising: a plurality of low temperature refrigeration circuits, with each low temperature refrigeration circuit comprising a low temperature refrigerant having a GWP of about 150 or less and comprising at least about 75% by weight by weight of R1234yf, including specifically R-454C and R-455A, and a compressor having a compressor rating of two horse power or less, an inter-circuit heat exchanger in which said low temperature refrigerant condenses in the range of temperatures of from about −5° C. to about −15° C.; and a medium temperature refrigeration circuit containing medium temperature refrigerant, wherein said medium temperature refrigerant comprises, consists essentially of, or consists of at least about 74% by weight of HFO-1234ze(E), including particularly HDR165 and/or HDR-166, and an evaporator in which said medium temperature refrigerant evaporates at a temperature below said low temperature refrigerant condensing temperature and in the range of about −5° C. to about −15° C., wherein said medium temperature refrigerant evaporates in said heat exchanger by absorbing heat from said low temperature refrigerant.

Cascade Refrigeration System—Alternatives

As the person skilled in the art will appreciate in view of the teachings contained here, there may be in accordance with the present invention, including each of Cascade Systems 1-21, any number of low stage refrigeration circuits 220. In particular, there may be as many low stage circuits 220 as there are refrigeration units to be cooled. Accordingly, the high stage refrigeration circuit 210 may be interfaced with any number of low stage refrigeration circuits 220, and visa versa.

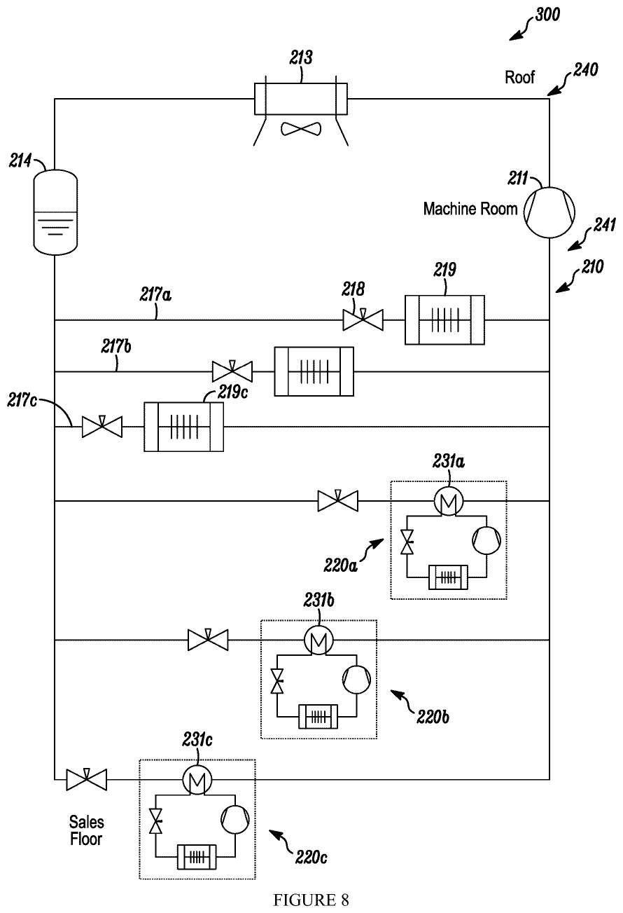

As will be clear to the skilled person in view of the teachings contained here, there may be in accordance with the present invention, including each of Cascade Systems 1-21, any number and arrangement of high stage circuit branches 217 and evaporators 218. In alternative arrangements in accordance with the present invention, including each of Cascade Systems 1-21, each low stage circuit 220 may be arranged fully in parallel with each other low stage circuit 220. An example of such an arrangement is shown in FIG. 8. FIG. 8 shows a system 300 where each circuit interface location present in inter-circuit heat exchangers 231a, 231b, 231c is arranged fully in parallel with each other circuit interface location. The components of the system 300 are otherwise the same as in system 200 (described in reference to FIG. 7), and components of the system 300 function in substantially the same way as the system 200, although it will be appreciated that the performance of the overall system and other important features of the overall system can be significantly impacted by this change in the arrangement.

Usefully, this means that a given portion of refrigerant from the high stage circuit 210 only passes through one inter-circuit heat exchanger 230 before it is returned to the compressor 211. This arrangement thus ensures that each of the heat exchangers 230 will receive high stage refrigerant at about the same temperature, since the arrangement prevents any of the heat exchangers from receiving a portion of the refrigerant that is pre-warmed as a result of passing through an upstream heat exchanger, as would be the case in a series arrangement.

As will be clear to the person skilled in the art in view of the teachings contained here, many other arrangements of the circuit interface locations 231a, 231b, 231c with respect to one and the high stage refrigeration circuit 210 can be achieved in accordance with the present invention, including each of Cascade Systems 1-21, and indeed are envisaged.

As will be clear to the person skilled in the art in view of the teachings contained here, by virtue of the preferred modular design of the low stage circuits of the preferred embodiments of the present invention, including each of Cascade Systems 1-21, allows use of non-flammable, low-pressure refrigerants with relatively low GWP.

Suction Line Heat Exchanger

A further possible alteration of any of the systems forming part of this disclosure including each of Cascade Systems 1-21, is that any number of the self-contained refrigeration circuits may include a suction line heat exchanger (SLHX). More specifically, any of the low stage refrigeration circuits 220a, 220b, 220c in system 200, including each of Cascade Systems 1-21, may include an SLHX; and any of the low stage refrigeration circuits 420a, 420b may include an SLHX.

The use of the SLX lowers the the temperature of the refrigerant entering the expansion valve 730. This additional sub-cooling leads to lower inlet quality in the evaporator 740 after the expansion valve 730 process. This increases the enthalpy difference and so the capacity of the refrigerant to absorb heat in the evaporator 740 stage is increased. Accordingly, the performance of the evaporator 740 is improved.

In summary both the first and second effects of improved evaporator capacity and improved compressor power requirements need to be considered in order to determine whether or not introducing a SLHX results in an overall beneficial effect. Generally, the use of a SLHX in accordance with the present invention, including each of Cascade Systems 1-21 and in particular such systems 200 and 300 herein, leads to an overall positive and unexpectedly beneficial effect.

Methods

Air Conditioning Methods

The present invention also relates to an air conditioning system comprising a refrigerant or of the invention, including each of Refrigerants 1-10, or heat transfer composition comprising a refrigerant of the present invention, including each of Heat Transfer Compositions 1-1. The present invention also provides a method of air conditioning using an air conditioning system, said method comprising the steps of (a) evaporating a refrigerant composition of the invention, including each of Refrigerants 1-10, in the vicinity of a fluid of body to be cooled, and (b) condensing said refrigerant. Air may be conditioned either directly or indirectly by the refrigerants of the invention, including each of Refrigerants 1-10. Examples of air conditioning systems include chillers, residential, industrial, commercial, and mobile air-conditioning including air conditioning of road vehicles such as automobiles, trucks and buses, as well as air conditioning of boats, and trains.

Preferred refrigeration systems of the present invention include chillers comprising a refrigerant of the present invention, including particularly each of Refrigerants 1-10.

Preferred refrigeration systems of the present invention include residential air-conditioning systems comprising a refrigerant of the present invention, including particularly each of Refrigerants 1-10.

Preferred refrigeration systems of the present invention include industrial air-conditioning systems comprising a refrigerant of the present invention, including particularly each of Refrigerants 1-10.

Preferred refrigeration systems of the present invention include commercial air-conditioning systems comprising a refrigerant of the present invention, including particularly each of Refrigerants 1-10.

Preferred refrigeration systems of the present invention include mobile air-conditioning systems comprising a refrigerant of the present invention, including particularly each of Refrigerants 1-10.

It will be appreciated that any of the above refrigeration, air conditioning or heat pump systems using the refrigerant of the invention, including each of Refrigerants 1-10, or heat transfer compositions comprising a refrigerant of the present invention, including each of Heat Transfer Compositions 1-11, may comprise a suction line/liquid line heat exchanger (SL-LL HX).

Organic Rankine Cycle Systems

The refrigerant composition of the invention, including each of Refrigerants 1-10, or a heat transfer composition comprising a refrigerant of the present invention, including each of Heat Transfer Compositions 1-11, may be used in an organic Rankine cycle (ORC). In the context of ORC, the refrigerant used in these systems may also be categorized as the “working fluid”. Rankine cycle systems are known to be a simple and reliable means to convert heat energy into mechanical shaft power.

In industrial settings, it may be possible to use flammable working fluids such as toluene and pentane, particularly when the industrial setting has large quantities of flammables already on site in processes or storage. However, for instances where the risk associated with use of a flammable and/or toxic working fluid is not acceptable, such as power generation in populous areas or near buildings, it is necessary to use non-flammable and/or non-toxic refrigerants as the working fluid. There is also a drive in the industry for these materials to be environmentally acceptable in terms of GWP.

The process for recovering waste heat in an Organic Rankine cycle system involves pumping liquid-phase working-fluid through a heat exchanger (boiler) where an external (waste) heat source, such as a process stream, heats the working fluid causing it to evaporate into a saturated or superheated vapor. This vapor is expanded through a turbine wherein the waste heat energy is converted into mechanical energy. Subsequently, the vapor phase working fluid is condensed to a liquid and pumped back to the boiler in order to repeat the heat extraction cycle. Therefore, the invention relates to the use of a refrigerant of the invention, including each of Refrigerants 1-10, or a heat transfer composition comprising a refrigerant of the present invention, including each of Heat Transfer Compositions 1-11, in an Organic Rankine Cycle.

Therefore, the invention provides a process for converting thermal energy to mechanical energy in a Rankine cycle, the method comprising the steps of i) vaporizing a working fluid with a heat source and expanding the resulting vapor, or vaporizing a working fluid with a heat source and expanding the resulting vapor, then ii) cooling the working fluid with a heat sink to condense the vapor, wherein the working fluid is a refrigerant or of the invention, including each of Refrigerants 1-11, or heat transfer compositions comprising a refrigerant of the present invention, including each of Heat Transfer Compositions. The mechanical work may be transmitted to an electrical device such as a generator to produce electrical power.

The heat source may be provided by a thermal energy source selected from industrial waste heat, solar energy, geothermal hot water, low pressure steam, distributed power generation equipment utilizing fuel cells, an internal combustion engine, or prime movers. Preferably, the low-pressure stream is a low-pressure geothermal steam or is provided by a fossil fuel powered electrical generating power plant.

It will be appreciated that the heat source temperatures can vary widely, for example from about 90° C. to >800° C., and can be dependent upon a myriad of factors including geography, time of year, etc. for certain combustion gases and some fuel cells. Systems based on sources such as waste water or low pressure steam from, e.g., a plastics manufacturing plants and/or from chemical or other industrial plant, petroleum refinery, and the like, as well as geothermal sources, may have source temperatures that are at or below about 100° C., and in some cases as low as about 90° C. or even as low as about 80° C. Gaseous sources of heat such as exhaust gas from combustion process or from any heat source where subsequent treatments to remove particulates and/or corrosive species result in low temperatures may also have source temperatures that are at or below about 130° C., at or below about 120° C., at or below about 100° C., at or below about 100° C., and in some cases as low as about 90° C. or even as low as about 80° C.

Electronic Cooling

The refrigerant compositions of the invention, including any one of Refrigerants 1 to 11, may be used in connection with systems and methods of electronic cooling, such as cooling of chips, electronic boards, batteries (including batteries used in cars, trucks, buses and other electronic transport vehicles), computers, and the like.

### EXAMPLES

In the examples which follow, refrigerant compositions in accordance with the present invention are identified as compositions E1-E7 in Table E below. Each of the refrigerants was tested and evaluated by applicants and found to be non-flammable, that is, to be a Class A1 refrigerant, and each of E1-E7 was also subjected to thermodynamic analysis to determine its ability to match the operating characteristics of R-134a in various refrigeration systems. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) was used for the Examples. Each blend was also evaluated to determine its classification for flammability as described above.

TABLE E1A
Refrigerants According to The Invention Tested for Performance

| | R1234ze(E) | R1224yd(Z) | R134a | GWP |
|---|---|---|---|---|
| Refrigerant | (wt. %) | (wt. %) | (wt. %) | (AR5) |
| E1 | 86% | 4% | 10% | 131 |
| E2A | 84% | 6% | 10% | 131 |
| E2B | 83.5% | 6.5% | 10% | 131 |
| E3 | 82% | 8% | 10% | 131 |
| E4 | 80% | 10% | 10% | 131 |
| E5 | 78% | 12% | 10% | 131 |
| E6 | 76% | 14% | 10% | 131 |
| E7 | 74% | 16% | 10% | 131 |

As can be seen from Table E1A above, each of the refrigerants E1-E7 according to the present invention achieves a GWP value (AR5) below 150 while at the same time achieving a flammability of Class A1.

For the purposes of comparison, five refrigerant blends outside of the scope of the refrigerants of the present invention were also analyzed to determine GWP. Each refrigerant was based on a combination of HFO-1234ze(E), HFO-1224yd(Z) an HFC-134 (1,1,1,2-tetrafluoroethane), and the results of the analysis are provided in the following Table C.

TABLE C
Comparative Refrigerants Tested for Performance

| | R1234ze(E) | R1224yd(Z) | R134 | GWP |
|---|---|---|---|---|
| Refrigerant | (wt. %) | (wt. %) | (wt. %) | (AR5) |
| C1 | 63 | 2 | 35 | 389 |
| C2 | 64 | 0.2 | 35.8 | >389 |
| C3 | 55.8 | 0.2 | 44 | >389 |
| C4 | 64 | 20 | 16 | >150 |
| C5 | 36 | 20 | 44 | >150 |

In contrast to the refrigerants of the present invention, none of refrigerants C1-C5 is able to achieve a GWP of less than 150.

### Examples 1A-1D: Performance in Medium Temperature Refrigeration System

Refrigerants E1 to E7 were performance tested in a medium temperature refrigeration system without a suction line/liquid line heat exchanger (SL/LL HX). The analysis was carried out to assess the efficiency (COP) of Refrigerants E1 to E7 in this system at different levels of effectiveness of the SL-LL HX under the conditions below.
(d) Operating conditions used for all the tests were:
Condensing temperature=45° C.
Condensing Temperature−Ambient Temperature=10° C.
Condenser sub-cooling=0.0° C. (system with receiver)
Evaporating temperature=−8° C.,
Evaporator Superheat=5.5° C.
Compressor Isentropic Efficiency=65%
Volumetric Efficiency=100%
Temperature Rise in Suction Line=10° C.
Suction Line/Liquid Line Heat Exchanger Effectiveness: 0%, 35%, 55%, 75%

The results a reported in Table E1A below.

TABLE E1A
Performance in Medium-Temperature Refrigeration
System with no SL/LL HX

| | Efficiency, | Capacity, | Evaporator |
|---|---|---|---|
| Refrigerant | % R-134a | % R134a | Glide, ° C. |
| R134a | 100% | 100% | 0 |
| E1 | 100% | 74% | 1.3 |
| E2A | 100% | 73% | 1.8 |
| E2B | 100% | 73% | 1.8 |
| E3 | 100% | 71% | 2.3 |
| E4 | 100% | 70% | 2.8 |
| E5 | 100% | 69% | 3.3 |
| E6 | 100% | 67% | 3.8 |
| E7 | 101% | 66% | 4.3 |

As revealed by the data reported in Table E1A, the refrigerants of the present invention, including E1-E7 and Refrigerants 1-10, are able to achieve a GWP (AR5) below 150 and have a flammability of class A1, but to also achieve an efficiency that is a very close match to R134a, a capacity of greater than 65% and an evaporator glide of 4.5 or less. This an unexpected and highly desirable result. Especially unexpected and highly desirable performance is achieved by refrigerants of the present invention represented by E1-E5 in that these refrigerants achieve the following highly desirable but very difficult to achieve combination of properties:
a. GWP (AR5)<150
b. Class A1 flammability
c. COP of 100
d. Capacity of 65% or greater
e. Evaporator Glide of 3.5° C. or less

Especially advantageous and unexpected results are achieved by refrigerants in the range represented by E1-E3, and in particular E2A and E2B, because of their ability to achieve the following combination of properties:
a. GWP (AR5)<150
b. Class A1 flammability
c. COP of 100
d. Capacity of 70% or greater
e. Evaporator Glide of 2.5° C. or less

Similar results are achieved as shown above when a suction line/liquid line heat exchanger is included in the system at efficiencies of 35%, 55% and 75%, as reported in Tables E1B, E1C and E1D below.

TABLE E1B
Performance in Medium-Temperature Refrigeration
System with SL/LL HX @ 35%

| | Efficiency (% R-134a) | | |
|---|---|---|---|
| | @35% SL/LL HX | Capacity, | Evaporator |
| Refrigerant | effectiveness | % R-134a | Glide, ° C. |
| R134a | 100% | 100% | 0 |
| E1 | 101% | 75% | 1.4 |
| E2A | 101% | 73% | 1.9 |
| E2B | 101% | 73% | 1.9 |
| E3 | 101% | 72% | 2.5 |
| E4 | 101% | 71% | 3.0 |
| E5 | 101% | 69% | 3.5 |
| E6 | 101% | 68% | 4.0 |
| E7 | 102% | 67% | 4.5 |

TABLE E1C
Performance in Medium-Temperature Refrigeration
System with SL/LL HX @ 55%

| | Efficiency(% R-134a) | | |
|---|---|---|---|
| | @55% SL/LL HX | Capacity, | Evaporator |
| Refrigerant | effectiveness | % R-134a | Glide, ° C. |
| R134a | 100% | 100% | 0 |
| E1 | 101% | 75% | 1.4 |
| E2A | 102% | 74% | 2.0 |
| E2B | 102% | 74% | 2.0 |
| E3 | 102% | 73% | 2.6 |
| E4 | 102% | 71% | 3.1 |
| E5 | 102% | 70% | 3.6 |
| E6 | 102% | 69% | 4.1 |
| E7 | 102% | 67% | 4.6 |

TABLE E1D
Performance in Medium-Temperature Refrigeration
System with SL/LL HX @ 75%

| | Efficiency(% R-134a) | | |
|---|---|---|---|
| | @75% SL/LL HX | Capacity, | Evaporator |
| Refrigerant | effectiveness | % R-134a | Glide, ° C. |
| R134a | 100% | 100% | 0 |
| E1 | 102% | 76% | 1.5 |
| E2A | 102% | 74% | 2.1 |
| E2B | 102% | 74% | 2.1 |
| E3 | 102% | 73% | 2.6 |
| E4 | 102% | 72% | 3.2 |
| E5 | 102% | 70% | 3.7 |
| E6 | 102% | 69% | 4.2 |
| E7 | 103% | 68% | 4.7 |

### Example C1A—Performance of in Medium Temperature Refrigeration System

(e) Examples E1A-E1 D are repeated, except that refrigerants C4 and C5 are tested for comparison purposes in terms of GWP, capacity, COP and glide. The C4 and C5 refrigerants were selected for comparison because those refrigerants had the lowest GWP among the refrigerants in Table C, although each of C4 and C5 have a GWP of greater than 150, as reported in Tables C1A-C1 D below. Tables C1A-C1 D below also shows the results in each case for refrigerants E2B and E4 for comparison as being representative of the performance of refrigerants of the present invention:

TABLE C1A
Comparative Performance in Medium-Temperature
Refrigeration System with no SL/LL HX

| | GWP | Efficiency, | Capacity, | Evaporator |
|---|---|---|---|---|
| Refrigerant | (AR5) | % R-134a | % R-134a | Glide, ° C. |
| R134a | 1300 | 100% | 100% | 0 |
| E2B | 131 | 100% | 73% | 1.8 |
| E4 | 131 | 100% | 70% | 2.8 |
| C4 | >150 | 102% | 63% | 4.9 |
| C5 | >150 | 103% | 65% | 5.2 |

As seen from Table C1A, the C4 and C5 refrigerants (which consist of HFO-1234ze(E), 1224yd(Z) and HFC-134) are not able to achieve a GWP less than 150, or an evaporator glide below 4.5° C., or a capacity above 65%. This illustrates some of the highly unexpected and advantageous results of the refrigerants of the present invention. Similar unexpected advantage is achieved with systems having a suction line/liquid line heat exchanger, as shown on Tables C1B-C1D below.

TABLE C1B
Comparative Performance in Medium-Temperature Refrigeration
System with SL/LL HX @ 35% Efficiency

| | | Efficiency (% R-134a) | | |
|---|---|---|---|---|
| | GWP | @35% SL/LL HX | Capacity, | Evaporator |
| Refrigerant | (AR5) | effectiveness | % R-134a | Glide, ° C. |
| R134a | 1300 | 100% | 100% | 0 |
| E2B | 131 | 102% | 74% | 2.1 |
| E4 | 131 | 101% | 71% | 3.0 |
| C4 | >150 | 103% | 63% | 5.1 |
| C5 | >150 | 103% | 65% | 5.5 |

TABLE C1C
Comparative Performance in Medium-Temperature Refrigeration
System with SL/LL HX @ 55% Efficiency

| | | Efficiency (% R-134a) | | |
|---|---|---|---|---|
| | GWP | @55% SL/LL HX | Capacity, | Evaporator |
| Refrigerant | (AR5) | effectiveness | % R-134a | Glide, ° C. |
| R134a | 1300 | 100% | 100% | 0 |
| E2B | 131 | 102% | 74% | 2.0 |
| E4 | 131 | 102% | 71% | 3.1 |
| C4 | >150 | 103% | 63% | 5.3 |
| C5 | >150 | 103% | 65% | 5.6 |

TABLE C1D
Comparative Performance in Medium-Temperature Refrigeration
System with SL/LL HX @ 55% Efficiency

| | | Efficiency, % R-134a | | |
|---|---|---|---|---|
| | GWP | @75% SL/LL HX | Capacity, | Evaporator |
| Refrigerant | (AR5) | effectiveness | % R-134a | Glide, ° C. |
| R134a | 1300 | 100% | 100% | 0 |
| E2B | 131 | 102% | 74% | 2.1 |
| E4 | 131 | 102% | 72% | 3.2 |
| C4 | >150 | 103% | 64% | 5.4 |
| C5 | >150 | 103% | 65% | 5.7 |

### Example 2: Performance in Low Temperature Refrigeration System with and without Suction Line/Liquid Line Heat Exchanger

Refrigerants E1 to E7 were performance tested in a low temperature refrigeration system with and without a suction line/liquid line heat exchanger (SL/LL HX). The analysis was carried out to assess the efficiency (COP) of Refrigerants E1 to E7 in this system at different levels of effectiveness of the SL-LL HX under the conditions below.
Operating conditions were:
Condensing temperature=45° C.
Condensing Temperature−Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=10° C.
Suction Line/Liquid Line Heat Exchanger Effectiveness: 0%, 35%, 55%, 75%

The results a reported in Table E2 below.

TABLE E2
Performance in Low-Temperature Refrigeration
System with SL/LL HX

| | Efficiency | Efficiency | Efficiency | Efficiency |
|---|---|---|---|---|
| | (% R-134a) | (% R-134a) | (% R-134a) | (% R-134a) |
| | @0% SL- | @35% SL- | @55% SL- | @75% SL- |
| | LL HX | LL HX | LL HX | LL HX |
| Refrigerant | effectiveness | effectiveness | effectiveness | effectiveness |
| R134a | 100% | 100% | 100% | 100% |
| E1 | ~98% | 100% | 101% | 102% |
| E2A | 98% | 100% | 101% | 102% |
| E2B | 98% | 100% | 101% | 102% |
| E3 | 98% | 100% | 101% | 102% |
| E4 | 98% | 100% | 101% | 102% |
| E5 | 98% | 100% | 101% | 102% |
| E6 | 99% | 100% | 101% | 102% |
| E7 | 99% | 100% | 101% | 102% |

Table 3 shows the performance of refrigerants in a low temperature refrigeration system. It will be understood that the results under the column with “0%” efficiency for the SL-LL HX represent a system without a SL-LL HX, and that Refrigerants E1-E7 show improved performance in terms of efficiency (COP) than R134a when a SL/LL Heat Exchanger is employed, with composition E1-E5 showing exceptional performance when all relevant performance factors are considered, for example, as explained in connection with Example 1.

### Example 3: Performance in Medium Temperature Refrigeration System with Two-Stage Vapor Injected Compression

Refrigerants E1 to E7 were performance tested in a medium temperature refrigeration system with two stage injection compression. The analysis was carried out to assess the efficiency (COP) of Refrigerants E1 to E7 in this system under the conditions below. Operating conditions were:
Condensing temperature=45° C.
Condensing Temperature−Ambient Temperature=10° C.
Condenser sub-cooling=5.0° C.
Evaporating temperature=−8° C., Corresponding box temperature=1.7° C.
Evaporator Superheat=5.5° C.
Compressor Isentropic Efficiency=70%
Volumetric Efficiency=100%
Temperature Rise in Suction Line=10° C.
Vapor Injection Heat Exchanger (HX) Effectiveness: 15%, 35%, 55%, 75%

The results a reported in Table E3 below.

TABLE E3
Performance in Medium-Temperature Refrigeration System
with Two-Stage Compression with Vapor Injection

| | Efficiency | Efficiency | Efficiency | Efficiency |
|---|---|---|---|---|
| | (% R-134a) | (% R-134a) | (% R-134a) | (% R-134a) |
| | @15% vapor | @35% vapor | @55% vapor | @75% vapor |
| | injection HX | injection HX | injection HX | injection HX |
| Refrigerant | effectiveness | effectiveness | effectiveness | effectiveness |
| R134a | 100% | 100% | 100% | 100% |
| E1 | 102% | 102% | 102% | 102% |
| E2A | 102% | 102% | 102% | 102% |
| E2B | 102% | 102% | 102% | 102% |
| E3 | 102% | 102% | 102% | 102% |
| E4 | 102% | 102% | 102% | 102% |
| E5 | 103% | 103% | 103% | 103% |
| E6 | 103% | 1033% | 103% | 103% |
| E7 | 103% | 103% | 103% | 103% |

Table E3 shows the performance of refrigerants in a medium temperature refrigeration system. Compositions E1 to E7 show improved performance in terms of efficiency (COP) than R134a in a two-stage compression with vapor injection, with composition E1-E5 showing exceptional performance when all relevant performance factors are considered, for example, as explained in connection with Example 1.

### Example 4: Performance of Refrigerants of the Invention in Cascade Refrigeration System

Cascade systems are generally used in applications where there is a large temperature difference (e.g., about 50-80° C., such as about 60-70° C.) between the ambient temperature and the box temperature (e.g., the difference in temperature between the airside of the condenser in the high stage, and the air-side of the evaporator in the low stage). For example, a cascade system may be used for freezing products in a supermarket. In this Example, exemplary compositions E1-E7 of the invention were tested as the refrigerant in the high stage of a cascade refrigeration system with each of the following compositions being used in the low stage: CO2, Propane, R1234yf; R454C; and R455AC. In Tables E4A-E4E below, performance is compared to R-134a as the base-line refrigerant in both the high stage and in the low stage.

Operating conditions were:
Condensing temperature=45° C.
High-stage Condensing Temperature−Ambient Temperature=10° C.
High-stage condenser sub-cooling=0.0° C. (system with receiver)
Evaporating temperature=−30° C., Corresponding box temperature=−18° C.
Low-stage Evaporator Superheat=3.3° C.
High-stage and Low-stage Compressor Isentropic Efficiency=65%
Volumetric Efficiency=100%
Temperature Rise in Suction Line Low Stage=15° C.
Temperature Rise in Suction Line High Stage=10° C.
Intermediate Heat Exchanger with indicated low stage refrigerant Condensing Temperature=0 C, 5° C. and 10° C.
Intermediate Heat Exchanger Superheat=3.3° C.
Difference in Temperature in Intermediate Heat Exchanger=8° C.

The performance results are reported in Tables E4A-E4E.

TABLE E4A
Performance of Refrigerants of The Invention in High Stage
of Cascade Refrigeration System and CO2 in Low Stage

| | Efficiency | Efficiency | Efficiency |
|---|---|---|---|
| Refrigerant in | (% R-134a) @ | (% R-134a) @ | (% R-134a) @ |
| high stage | Tcond = 0° C. | Tcond = 5° C. | Tcond = 10° C. |
| R134a - Baseline | 100% | 100% | 100% |
| E1 | 100% | 100% | 100% |
| E2A | 100% | 100% | 100% |
| E2B | 100% | 100% | 100% |
| E3 | 100% | 100% | 100% |
| E4 | 100% | 100% | 100% |
| E5 | 100% | 100% | 100% |
| E6 | 100% | 100% | 100% |
| E7 | 100% | 100% | 100% |

TABLE E4B
Performance of Refrigerants of The Invention in High Stage
of Cascade Refrigeration System and Propane in Low Stage

| | Efficiency | Efficiency | Efficiency |
|---|---|---|---|
| Refrigerant in | (% R-134a) @ | (% R-134a) @ | (% R-134a) @ |
| high stage | Tcond = 0° C. | Tcond = 5° C. | Tcond = 10° C. |
| R134a - Baseline | 100% | 100% | 100% |
| E1 | 107% | 110% | 114% |
| E2A | 107% | 110% | 114% |
| E2B | 107% | 110% | 114% |
| E3 | 107% | 110% | 114% |
| E4 | 107% | 110% | 114% |
| E5 | 107% | 110% | 114% |
| E6 | 107% | 110% | 114% |
| E7 | 107% | 110% | 114% |

TABLE E4C
Performance of Refrigerants of The Invention in High Stage
of Cascade Refrigeration System and R1234yf in Low Stage

| | Efficiency | Efficiency | Efficiency |
|---|---|---|---|
| Refrigerant in | (% R-134a) @ | (% R-134a) @ | (% R-134a) @ |
| high stage | Tcond = 0° C. | Tcond = 5° C. | Tcond = 10° C. |
| R134a | 100% | 100% | 100% |
| E1 | 106% | 108% | 112% |
| E2A | 106% | 108% | 112% |
| E2B | 106% | 108% | 112% |
| E3 | 106% | 108% | 112% |
| E4 | 106% | 108% | 112% |
| E5 | 106% | 108% | 112% |
| E6 | 106% | 108% | 112% |
| E7 | 106% | 108% | 112% |

TABLE E4D
Performance of Refrigerants of The Invention in High Stage of
a Cascade Refrigeration System and with R455A in Low Stage

| | Efficiency | Efficiency | Efficiency |
|---|---|---|---|
| Refrigerant in | (% R-134a) @ | (% R-134a) @ | (% R-134a) @ |
| high stage | Tcond = 0° C. | Tcond = 5° C. | Tcond = 10° C. |
| R134a - Baseline | 100% | 100% | 100% |
| E1 | 105% | 108% | 112% |
| E2A | 105% | 108% | 112% |
| E2B | 105% | 108% | 112% |
| E3 | 105% | 108% | 112% |
| E4 | 105% | 108% | 112% |
| E5 | 105% | 108% | 112% |
| E6 | 105% | 108% | 112% |
| E7 | 105% | 108% | 112% |

TABLE E4E
Performance of Refrigerants of The Invention in High Stage
of Cascade Refrigeration System and R454C in Low Stage

| | Efficiency | Efficiency | Efficiency |
|---|---|---|---|
| Refrigerant in | (% R-134a) @ | (% R-134a) @ | (% R-134a) @ |
| high stage | Tcond = 0° C. | Tcond = 5° C. | Tcond = 10° C. |
| R134a - Baseline | 100% | 100% | 100% |
| E1 | 106% | 109% | 113% |
| E2A | 106% | 109% | 113% |
| E2B | 106% | 109% | 113% |
| E3 | 106% | 109% | 113% |
| E4 | 106% | 109% | 113% |
| E5 | 106% | 109% | 113% |
| E6 | 106% | 109% | 113% |
| E7 | 106% | 109% | 113% |

Tables E4A-E4E show the performance of the refrigerants of the present invention in the high stage of a cascade refrigeration system with various refrigerants in the low stage. These tables show that Refrigerants E1 to E7 match the efficiency of R134a for different condensing temperatures of the low stage cycle, with composition E1-E5 showing exceptional performance when all relevant performance factors are considered, for example, as explained in connection with Example 1.

### Example 5: Performance in Vending Machines with/without Suction Line/Liquid Line Heat Exchanger

Refrigerants E1 to E7 were performance tested in a vending machine refrigeration system with and without a suction line/liquid line heat exchanger (SL/LL HX). The analysis was carried out to assess the efficiency (COP) of Refrigerants E1 to E7 in this system at different levels of effectiveness of the SL-LL HX under the conditions below.
Operating conditions:
Condensing temperature=45° C.
Condensing Temperature−Ambient Temperature=10° C.
Condenser sub-cooling=5.5° C.
Evaporating temperature=−8° C.,
Evaporator Superheat=3.5° C.
Compressor Isentropic Efficiency=60%
Volumetric Efficiency=100%
Temperature Rise in Suction Line=5° C.
Suction Line/Liquid Line Heat Exchanger Effectiveness: 0%, 35%, 55%, 75%

The performance results are reported in Table E5 below.

TABLE E5
Performance in Vending Machine with SL/LL HX

| | Efficiency | Efficiency | Efficiency | Efficiency |
|---|---|---|---|---|
| | (% R-134a) | (% R-134a) | (% R-134a) | (% R-134a) |
| | @0% SL- | @35% SL- | @55% SL- | @75% SL- |
| | LL HX | LL HX | LL HX | LL HX |
| Refrigerant | effectiveness | effectiveness | effectiveness | effectiveness |
| R134a | 100% | 100% | 100% | 100% |
| E1 | 100% | 101% | 101% | 102% |
| E2A | 100% | 101% | 101% | 102% |
| E2B | 100% | 101% | 101% | 102% |
| E3 | 100% | 101% | 101% | 102% |
| E4 | 100% | 101% | 101% | 102% |
| E5 | 100% | 101% | 102% | 102% |
| E6 | 100% | 101% | 102% | 102% |
| E7 | 100% | 101% | 102% | 102% |

Table E5 shows performance of refrigerants E1-E7 in a vending machine system with and without SL/LL HX. It will be understood that the results under the column with “0%” efficiency for the SL-LL HX represent a system without a SL-LL HX, and that Refrigerants E1 to E7 show improved performance in terms of efficiency (COP) than R134a when a SL/LL Heat Exchanger is employed, with composition E1-E5 showing exceptional performance when all relevant performance factors are considered, for example, as explained in connection with Example 1.

### Example 6: Performance in Air-Source Heat Pump Water Heaters

Refrigerants E1 to E7 were performance tested in an air source heat pump water heater system. The analysis was carried out to assess the efficiency (COP) of Refrigerants E1 to E7 in this system under the conditions below.
Operating conditions were:
Condensing temperature=55° C.
Water Inlet Temperature=45° C., Water Outlet Temperature=50° C.
Condenser sub-cooling=5.0° C.
Evaporating temperature=−5° C., Corresponding ambient temperature=10° C.
Evaporator Superheat=3.5° C.
Compressor Isentropic Efficiency=65%
Volumetric Efficiency=100%
Temperature Rise in Suction Line=5° C.
Suction Line/Liquid Line Heat Exchanger Effectiveness: 0%, 35%, 55%, 75%

The performance results are reported in Table E6 below.

TABLE E6
Performance in Heat Pump Water Heaters

| | Efficiency | Comp. Discharge |
|---|---|---|
| Refrigerant | (% R-134a) | Temp (° C.) |
| R134a | 100% | 88.0 |
| E1 | 100% | 79.7 |
| E2A | 100% | 80.1 |
| E2B | 100% | 80.1 |
| E3 | 100% | 80.5 |
| E4 | 100% | 80.9 |
| E5 | 100% | 81.3 |
| E6 | 100% | 81.6 |
| E7 | 100% | 82.0 |

Table E6 shows performance of refrigerants E1-E7 in a heat pump water heater. Refrigerants E1 to E6 show efficiency similar to R134a, with compositions E1-E5 showing exceptional performance when all relevant performance factors are considered, for example, as explained in connection with Example 1. Refrigerants E1 to E7 show lower discharge temperature than R134a, indicating better reliability for the compressor.

### Example 7: Performance in Air-Source Heat Pump Water Heaters with Suction Line/Liquid Line Heat Exchanger

Refrigerants E1 to E7 were performance tested in an air source heat pump water heater system with and without a suction line/liquid line heat exchanger (SL/LL HX). The analysis was carried out to assess the efficiency (COP) of Refrigerants E1 to E7 in this system at different levels of effectiveness of the SL-LL HX under the conditions below.

Operating conditions were:
Condensing temperature=55° C.
Water Inlet Temperature=45° C., Water Outlet Temperature=50° C.
Condenser sub-cooling=5.0° C.
Evaporating temperature=−5° C., Corresponding ambient temperature=10° C.
Evaporator Superheat=3.5° C.
Compressor Isentropic Efficiency=65%
Volumetric Efficiency=100%
Temperature Rise in Suction Line=5° C.
Suction Line/Liquid Line Heat Exchanger Effectiveness: 0%, 35%, 55%, 75%

The performance results are reported in Table E7 below.

TABLE E7
Performance in Heat Pump Water Heaters with SL/LL HX

| | SL-LL HX Eff. 35% | | SL-LL HX Eff. 55% | | SL-LL HX Eff. 75% | |
|---|---|---|---|---|---|---|
| | | Comp. | | Comp. | | Comp. |
| | | Discharge | | Discharge | | Discharge |
| Refrigerant | Efficiency | Temp (° C.) | Efficiency | Temp (° C.) | Efficiency | Temp (° C.) |
| R134a | 100% | 105.5 | 100% | 115.5 | 100% | 125.3 |
| E1 | 101% | 96.8 | 101% | 106.4 | 102% | 116.0 |
| E2A | 101% | 97.0 | 101% | 106.5 | 102% | 116.0 |
| E2B | 101% | 97.0 | 101% | 106.5 | 102% | 116.0 |
| E3 | 101% | 97.2 | 101% | 106.6 | 102% | 116.0 |
| E4 | 101% | 97.4 | 101% | 106.7 | 102% | 116.0 |
| E5 | 101% | 97.6 | 101% | 106.8 | 102% | 116.0 |
| E6 | 101% | 97.8 | 102% | 106.9 | 102% | 116.0 |
| E7 | 101% | 98.0 | 102% | 107.0 | 102% | 115.9 |

Table E7 shows performance of refrigerants in a heat pump water heater with SL/LL HX. Refrigerants E1 to E7 show higher efficiency than R134a when a SL/LL Heat Exchanger is employed, with compositions E1-E5 showing exceptional performance when all relevant performance factors are considered, for example, as explained in connection with Example 1. Refrigerants E1 to E7 show lower discharge temperature than R134a, indicating better reliability for the compressor.

### Example 8: Performance in Mobile Air Conditioning Systems (Buses, Trains, Cars)

Refrigerants E1 to E6 were performance tested in a mobile air conditioning system under various condenser temperature conditions. The analysis was carried out to assess the efficiency (COP) of Refrigerants E1 to E6 in this system under the conditions below

Operating Conditions:
Condensing temperature=45° C. to 75° C.
Condenser sub-cooling=5.0° C.
Evaporating temperature=4° C., corresponding indoor room temperature=35° C.
Evaporator Superheat=5.0° C.
Compressor Isentropic Efficiency=65%
Volumetric Efficiency=100%
Temperature Rise in Suction Line=0° C.

The performance results are reported in Table E8 below.

TABLE E8
Performance in Mobile AC systems

| | Condensing | Condensing | Condensing | Condensing |
|---|---|---|---|---|
| | 45° C. | 55° C. | 65° C. | 75° C. |
| Refrigerant | Efficiency | Efficiency | Efficiency | Efficiency |
| R134a | 100% | 100% | 100% | 100% |
| E1 | 100% | 100% | 100% | 100% |
| E2A | 100% | 100% | 100% | 100% |
| E2B | 100% | 100% | 100% | 100% |
| E3 | 100% | 100% | 100% | 100% |
| E4 | 100% | 100% | 100% | 101% |
| E5 | 101% | 101% | 101% | 101% |
| E6 | 101% | 101% | 101% | 101% |
| E7 | 101% | 101% | 101% | 102% |

In Table E8, Refrigerants E1 to E7 show efficiency similar to R134a over a range of condensing temperatures which correspond to different ambient temperatures, with compositions E1-E5 showing exceptional performance when all relevant performance factors are considered, for example, as explained in connection with Example 1.

### Example 9: Performance of Refrigerants of the Invention in Micro-Cascade Refrigeration System

A micro-cascade system combines a traditional medium temperature DX refrigeration system, with or without suction line liquid line heat exchanger (SLHX), which operates with refrigerants E1-E7 in the high stage of a micro cascade with low stage comprising several small low temperature self-contained refrigeration systems running the following refrigerants in the low stage: CO₂; Propane R1234yf; R454C and R455A. As used herein, the term “medium temperature DX refrigeration system” refers to a medium temperature system in which the evaporator is a dry evaporator. A useful micro-cascade system is disclosed in U.S. Ser. No. 16/014,863 filed Jun. 21, 2018, and U.S. Ser. No. 16/015,145 filed Jun. 21, 2018, claiming priority to U.S. Ser. 62/522,386 filed Jun. 21, 2017, U.S. Ser. 62/522,846 filed Jun. 21, 2017, 62/522,851 filed Jun. 21, 2017, and Ser. 62/522,860 filed Jun. 21, 2017, all of which are incorporated herein by reference in their entireties. For the purposes of comparison, a base-line system operating with R-404A operating in the high stage and in a single high-capacity vapor compressor in the low stage is also tested.

Operating Conditions:

Baseline R404A combined MT and LT (non-micro) system
Refrigeration Capacity
   Low Temperature: 33,000W
   Medium Temperature: 67,000W
Volumetric efficiency: 95% for both MT ad LT
Compressor Isentropic efficiency
   Medium Temperature=70% and Low Temperature=67%
Condensing temperature: 105° F.
Medium Temperature evaporation temperature: 20° F.
Low Temperature evaporation temperature: −20° F.
Evaporator superheat: 10° F. (both Medium and Low Temperature)
Suction line temperature rise (due to heat transfer to surroundings)
   Baseline: Medium Temperature: 25° F.; Low Temperature: 50° F.
   Cascade/self-contained without SLHX: Medium Temperature: 10° F.; Low Temperature: 25° F.
   Cascade/self-contained with SLHX: Medium Temperature: 10° F.; Low Temperature: 15° F.
SLHX efficiency when used: 65%

The performance results are reported in Table E9A-E9E below.

TABLE E9A
Comparison between R404A and the micro-cascade
system with Inventive Refrigerants in the
High Stage and CO2 in the Low Stage

| | High stage (medium | Low stage (Low | Relative COP |
|---|---|---|---|
| Systems | temperature) | temperature) | % of R404A |
| R404A | R404A | | 100% |
| Cascade with | E1 | CO2 | 122% |
| CO₂ | E2A and E2B | CO2 | 122% |
| | E3 | CO2 | 122% |
| | E4 | CO2 | 122% |
| | E5 | CO2 | 122% |
| | E6 | CO2 | 122% |
| | E7 | CO2 | 122% |

TABLE E9B
Comparison between R404A and the micro-cascade
system with Inventive Refrigerants in the
High Stage and propane in the low stage

| | High stage (medium | Low stage (Low | Relative COP |
|---|---|---|---|
| Systems | temperature) | temperature) | % of R404A |
| R404A | R404A | | 100% |
| Cascade with | E1 | Propane | 127% |
| Propane | E2A and E2B | Propane | 127% |
| | E3 | Propane | 127% |
| | E4 | Propane | 127% |
| | E5 | Propane | 127% |
| | E6 | Propane | 127% |
| | E7 | Propane | 127% |

TABLE E9C
Comparison between R404A and the micro-cascade
system with Inventive Refrigerants in the
High Stage and R-1234yf in the Low Stage

| | High stage (medium | Low stage (Low | Relative COP |
|---|---|---|---|
| Systems | temperature) | temperature) | % of R404A |
| R404A | R404A | | 100% |
| Cascade with | E1 | R1234yf | 126% |
| R1234yf | E2A and E2B | R1234yf | 126% |
| | E3 | R1234yf | 126% |
| | E4 | R1234yf | 126% |
| | E5 | R1234yf | 126% |
| | E6 | R1234yf | 126% |
| | E7 | R1234yf | 126% |

TABLE E9D
Comparison between R404A and the micro-cascade
system with Inventive Refrigerants in the
High Stage and R454C in the Low Stage

| | High stage (medium | Low stage (Low | Relative COP |
|---|---|---|---|
| Systems | temperature) | temperature) | % of R404A |
| R404A | R404A | | 100% |
| Cascade with | E1 | R454C | 126% |
| R454C | E2A and E2B | R454C | 126% |
| | E3 | R454C | 126% |
| | E4 | R454C | 126% |
| | E5 | R454C | 126% |
| | E6 | R454C | 126% |
| | E7 | R454C | 126% |

TABLE E9E
Comparison between R404A and the micro-cascade
system with Inventive Refrigerants in the
High Stage and R-455A in the Low Stage

| | High stage (medium | Low stage (Low | Relative COP |
|---|---|---|---|
| Systems | temperature) | temperature) | % of R404A |
| R404A | R404A | | 100% |
| Cascade with | E1 | R455A | 126% |
| R455A | E2A and E2B | R455A | 126% |
| | E3 | R455A | 126% |
| | E4 | R455A | 126% |
| | E5 | R455A | 126% |
| | E6 | R455A | 126% |
| | E7 | R455A | 126% |

The Tables E9A through E9E above show that the micro-cascade system has about at least 120% higher COP than a baseline medium temperature DX system with R404A.

### Example 10: Non-Flammable Secondary Refrigerants with Pressure Above Atmospheric Pressure

The refrigerants of the present invention, including Refrigerants E1-E7, are useful as secondary fluids in secondary fluid refrigeration systems. The refrigerants of the invention, including each of Refrigerants E1-E7, have the necessary properties to ensure that the operating pressure of the refrigerant is not below atmospheric pressure at the given evaporator temperature, so that air would not enter the system and at the same time it is low enough to prevent significant leaks.
Table 10 shows the pressure of refrigerants for evaporating temperatures ranging from −5° C. to 10° C. which cover the various operating conditions for air conditioning applications.
It can be observed from Table 10 that all refrigerants maintain pressure higher than atmospheric pressure.
The primary refrigerant used in the vapor compression loop may be selected from the group consisting of R404A, R507, R410A, R455A, R32, R466A, R44B, R290, R717, R452B, R448A, R1234ze(E), R1234yf and R449A.
The temperature of the air (or body) to be cooled may be from about 25° C. to about 0° C.

TABLE 10
Secondary Fluids

| Secondary | Evaporator Temperature | Evaporator Pressure |
|---|---|---|
| Refrigerant | (° C.) | (bar) |
| E1 | −5 | 1.9 |
| | 0 | 2.2 |
| | 10 | 3.2 |
| E2A and E2B | −5 | 1.8 |
| | 0 | 2.2 |
| | 10 | 3.2 |
| E3 | −5 | 1.8 |
| | 0 | 2.2 |
| | 10 | 3.1 |
| E4 | −5 | 1.8 |
| | 0 | 2.2 |
| | 10 | 3.1 |
| E5 | −5 | 1.8 |
| | 0 | 2.1 |
| | 10 | 3.1 |
| E6 | −5 | 1.8 |
| | 0 | 2.1 |
| | 10 | 3.0 |
| E7 | −5 | 1.7 |
| | 0 | 2.1 |
| | 10 | 3.0 |

### Example 11: Performance in Stationary Air Conditioning Systems

Refrigerants E1 to E7 were performance tested in a stationary air conditioning system under various condenser temperature conditions. The analysis was carried out to assess the efficiency (COP) of Refrigerants E1 to E7 in this system under the conditions below.

Operating Conditions:
Condensing temperature=45° C. to 65° C.
Condenser sub-cooling=5.0° C.
Evaporating temperature=10° C., corresponding indoor room temperature=35° C.
Evaporator Superheat=5.0° C.
Compressor Isentropic Efficiency=72%
Volumetric Efficiency=100%

TABLE 11
Performance in Stationary AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| E1 | 101% | 101% | 101% |
| E2A | 101% | 101% | 101% |
| E2B | 101% | 101% | 101% |
| E3 | 101% | 101% | 101% |
| E4 | 101% | 101% | 101% |
| E5 | 101% | 101% | 101% |
| E6 | 101% | 101% | 102% |
| E7 | 101% | 101% | 102% |

Refrigerants E1 to E7 show efficiency similar to R134a over range of condensing temperatures which correspond to different ambient temperatures, with compositions E1-E5 showing exceptional performance when all relevant performance factors are considered, for example, as explained in connection with Example 1.

### Example 12: Performance in Commercial Air Conditioning Systems

Refrigerants E1 to E7 were performance tested in a commercial air conditioning system under various condenser temperature conditions. The analysis was carried out to assess the efficiency (COP) of Refrigerants E1 to E7 in this system under the conditions below.

Operating Conditions:
Condensing temperature=45° C. to 65° C.
Condenser sub-cooling=5.0° C.
Evaporating temperature=10° C.,
Evaporator Superheat=5.0° C.
Compressor Isentropic Efficiency=72%
Volumetric Efficiency=100%

TABLE 12
Performance in Commercial AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| E1 | 101% | 101% | 101% |
| E2A | 101% | 101% | 101% |
| E2B | 101% | 101% | 101% |
| E3 | 101% | 101% | 101% |
| E4 | 101% | 101% | 101% |
| E5 | 101% | 101% | 101% |
| E6 | 101% | 101% | 102% |
| E7 | 101% | 101% | 102% |

Refrigerants E1 to E6 show efficiency similar to R134a over range of condensing temperatures which correspond to different ambient temperatures, with compositions E1, E2, E3 and E4 showing exceptional performance when all relevant performance factors are considered, for example, as explained in connection with Example 1.

### Example 13: Performance in Extreme Temperature Air Conditioning Systems

Refrigerants E1 to E7 were performance tested in a stationary air conditioning system under various condenser temperature conditions. The analysis was carried out to assess the efficiency (COP) of Refrigerants E1 to E7 in this system under the conditions below.

Operating Conditions:
Condensing temperature=55° C. to 95° C.
Condenser sub-cooling=5.0° C.
Evaporating temperature=10° C., corresponding indoor room temperature=35° C.
Evaporator Superheat=5.0° C.
Compressor Isentropic Efficiency=65%
Volumetric Efficiency=100%

TABLE 13
Performance in Stationary AC systems

| | Condensing | Condensing | Condensing |
|---|---|---|---|
| | 55° C. | 75° C. | 95° C. |
| Refrigerant | Efficiency | Efficiency | Efficiency |
| R134a | 100% | 100% | 100% |
| E1 | 101% | 101% | 101% |
| E2A | 101% | 101% | 102% |
| E2B | 101% | 101% | 102% |
| E3 | 101% | 101% | 103% |
| E4 | 101% | 101% | 104% |
| E5 | 101% | 102% | 105% |
| E6 | 102% | 102% | 106% |
| E7 | 102% | 102% | 106% |

Refrigerants E1 to E7 show efficiency similar to R134a over range of condensing temperatures which correspond to different ambient temperatures, with compositions E1-E5 showing exceptional performance when all relevant performance factors are considered, for example, as explained in connection with Example 1.

### Comparative Example C2—Performance in Extreme Temperature Air Conditioning Systems

Example E13 with the condenser temperature at 75° C. is repeated, except that refrigerants C4 and C5 are tested for comparison purposes in terms of GWP, capacity, COP and glide. The C4 and C5 refrigerants were selected for comparison because those refrigerants had the lowest GWP among the refrigerants in Table C, although each of C4 and C5 have a GWP of greater than 150, as reported in Table C2. Table C2 below also shows the results in each case for refrigerant E2B and E4 for comparison as being representative of the performance of refrigerants of the present invention:

TABLE C2
Comparative Performance in Extreme Air Conditioning Systems

| | GWP | | | Evaporator |
|---|---|---|---|---|
| Refrigerant | (AR5) | Efficiency | Capacity | Glide, ° C. |
| R134a | 1300 | 100% | 100% | 0 |
| E2B | 131 | 101% | 74% | 1.6 |
| E4 | 131 | 101% | 72% | 2.3 |
| C4 | >150 | 105% | 66% | 4.1 |
| C5 | >150 | 107% | 70% | 4.5 |

As seen from Table C2, the C4 and C5 refrigerants (which consist of HFO-1234ze(E), 1224yd(Z) and HFC-134) are not able to achieve a GWP less than 150, or an evaporator glide below 3° C., a capacity above 70% or an efficiency that matches the efficiency of R134a as closely asE2B or E4 does. This illustrates the highly unexpected and advantageous results of the refrigerants of the present invention.

### Example 14: Performance in High Temperature Heat Pump Systems

Refrigerants E1 to E7 were performance tested in a stationary air conditioning system under various condenser temperature conditions. The analysis was carried out to assess the efficiency (COP) of Refrigerants E1 to E7 in this system under the conditions below.

Operating Conditions:
Condensing temperature=55° C. to 95° C.
Condenser sub-cooling=5.0° C.
Evaporating temperature=30° C.
Evaporator Superheat=5.0° C.
Compressor Isentropic Efficiency=65%
Volumetric Efficiency=100%

TABLE 14
Performance in High Temperature Heat Pump Systems

| | Condensing | Condensing | Condensing |
|---|---|---|---|
| | 55° C. | 75° C. | 95° C. |
| Refrigerant | Efficiency | Efficiency | Efficiency |
| R134a | 100% | 100% | 100% |
| E1 | 101% | 102% | 103% |
| E2A | 101% | 102% | 103% |
| E2B | 101% | 102% | 103% |
| E3 | 102% | 102% | 103% |
| E4 | 102% | 102% | 104% |
| E5 | 102% | 102% | 104% |
| E6 | 102% | 103% | 105% |
| E7 | 102% | 103% | 105% |

Refrigerants E1 to E7 show efficiency similar to R134a over range of condensing temperatures which correspond to different ambient temperatures, with compositions E1-E5 showing exceptional performance when all relevant performance factors are considered, as explained, for example in connection with Example E1.

### Comparative Example C3—Performance in High Temperature Heat Pump Systems

Example E14 with the condenser temperature at 75° C. is repeated, except that refrigerants C4 and C5 are tested for comparison purposes in terms of GWP, capacity, COP and glide. The C4 and C5 refrigerants were selected for comparison because those refrigerants had the lowest GWP among the refrigerants in Table C, although each of C4 and C5 have a GWP of greater than 150, as reported in Table C3. Table C3 below also shows the results in each case for refrigerant E2B and E4 for comparison as being representative of the performance of refrigerants of the present invention:

TABLE C3
Comparative Performance in Extreme Air Conditioning Systems

| | GWP | | | Evaporator |
|---|---|---|---|---|
| Refrigerant | (AR5) | Capacity | Efficiency | Glide, ° C. |
| R134a | 1300 | 100% | 100% | 0 |
| E2B | 131 | 76% | 102% | 1.6 |
| E4 | 131 | 74% | 102% | 2.4 |
| C4 | >150 | 68% | 104% | 4.2 |
| C5 | >150 | 70% | 105% | 4.6 |

As seen from Table C3, the C4 and C5 refrigerants (which consist of HFO-1234ze(E), 1224yd(Z) and HFC-134) are not able to achieve a GWP less than 150, or an evaporator glide below 3° C., a capacity above 70% or an efficiency that matches the efficiency of R134a as closely as E2B or E4 does. This illustrates the highly unexpected and advantageous results of the refrigerants of the present invention.

### Example 15: Performance in Transport (Refrigerated Trucks, Containers) Medium Temperature Refrigeration Applications with and without Suction Line (SL)/Liquid Line (LL) Heat Exchanger (HX)

Refrigerants E1 to E7 were performance tested in a transport refrigeration system with and without a suction line/liquid line heat exchanger (SL/LL HX) at medium temperature refrigeration conditions. The analysis was carried out to assess the efficiency (COP) of Refrigerants E1 to E7 in this system at different levels of effectiveness of the SL-LL HX under the conditions below.

Operating conditions were:
Condensing temperature=45° C.
Condensing Temperature−Ambient Temperature=10° C.
Condenser sub-cooling=0.0° C. (system with receiver)
Evaporating temperature=−8° C.,
Evaporator Superheat=5.5° C.
Compressor Isentropic Efficiency=65%
Volumetric Efficiency=100%
Temperature Rise in Suction Line=15° C.
Suction Line/Liquid Line Heat Exchanger Effectiveness: 0%, 35%, 55%, 75%

TABLE 15
Performance in Medium-Temperature Transport
Refrigeration System with SL/LL HX

| | Efficiency | Efficiency | Efficiency | Efficiency |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| E1 | 100% | 101% | 101% | 102% |
| E2A | 100% | 101% | 102% | 102% |
| E2B | 100% | 101% | 102% | 102% |
| E3 | 100% | 101% | 102% | 102% |
| E4 | 100% | 101% | 102% | 102% |
| E5 | 100% | 101% | 102% | 102% |
| E6 | 100% | 101% | 102% | 102% |
| E7 | 101% | 102% | 102% | 103% |

Table 15 shows the performance of Refrigerants E1 to E7 in a transport refrigeration system. It will be understood that the results under the column with “0%” efficiency for the SL-LL HX represent a system without a SL-LL HX, and that Refrigerants E1 to E7 show improved performance in terms of efficiency (COP) than R134a when a SL/LL Heat Exchanger is employed, with compositions E1-E5 showing exceptional performance when all relevant performance factors are considered, as explained, for example in connection with Example E1.

### Example 16: Performance in Transport (Refrigerated Trucks, Containers) Low Temperature Refrigeration Applications with and without Suction Line/Liquid Line Heat Exchanger

Refrigerants E1 to E6 were performance tested in a transport refrigeration system with and without a suction line/liquid line heat exchanger (SL/LL HX) at low temperature refrigeration conditions. The analysis was carried out to assess the efficiency (COP) of Refrigerants E1 to E7 in this system at different levels of effectiveness of the SL-LL HX under the conditions below.

Operating conditions were:
Condensing temperature=45° C.
Condensing Temperature−Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=15° C.
Suction Line/Liquid Line Heat Exchanger Effectiveness: 0%, 35%, 55%, 75%

TABLE 16
Performance in Low-Temperature Transport
Refrigeration System with SL/LL HX

| | Efficien- | Efficien- | Efficien- | Efficien- |
|---|---|---|---|---|
| | cy@0% | cy@35% | cy@55% | cy@75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| E1 | ~98% | 100% | 101% | 102% |
| E2A | 98% | 100% | 101% | 102% |
| E2B | 98% | 100% | 101% | 102% |
| E3 | 98% | 100% | 101% | 102% |
| E4 | 98% | 100% | 101% | 102% |
| E5 | 98% | 100% | 101% | 102% |
| E6 | 99% | 100% | 101% | 102% |
| E7 | 99% | 100% | 101% | 102% |

It will be understood that the results under the column with “0%” efficiency for the SL-LL HX represent a system without a SL-LL HX, and that Refrigerants E1 to E7 show improved performance in terms of efficiency (COP) than R134a when a SL/LL Heat Exchanger is employed, with compositions E1-E5 showing exceptional performance when all relevant performance factors are considered, as explained, for example in connection with Example E1.

### Example 17: Electronic Cooling

Refrigerants E1 to E7 are performance tested to evaluate cooling of electronic equipment (including in the cooling of chips, electronic boards, batteries (including batteries used in cars, trucks, buses and other electronic transport vehicles), computers, and the like), including in the form of a heat pipe, a thermosiphon and the like, as well as vapor compression cooling. The analysis is carried out to assess the performance of Refrigerants E1 to E6 in these applications. Refrigerants E1 to E7 show performance similar to R134a, with compositions E1-E5 showing exceptional performance when all relevant performance factors are considered, as explained, for example in connection with Example E1.

### Example 18: Performance of Inventive Pairs of Refrigerants in Cascade Refrigeration System

As mentioned above, cascade systems are generally used in applications where there is a large temperature difference (e.g., about 50-80° C., such as about 60-70° C.) between the ambient temperature and the box temperature (e.g., the difference in temperature between the air-side of the condenser in the high stage, and the air-side of the evaporator in the low stage). For example, a cascade system may be used for freezing products in a supermarket. In this Example, inventive high stage/low stage pairs of refrigerants were tested in a cascade refrigeration system using R-134a as the baseline in the high stage and CO2 in the low stage.

Operating conditions were:
Condensing temperature=45° C.
High-stage Condensing Temperature−Ambient Temperature=10° C.
High-stage condenser sub-cooling=0.0° C. (system with receiver)
Evaporating temperature=−30° C., Corresponding box temperature=−18° C.
Low-stage Evaporator Superheat=3.3° C.
High-stage and Low-stage Compressor Isentropic Efficiency=65%
Volumetric Efficiency=100%
Temperature Rise in Suction Line Low Stage=15° C.
Temperature Rise in Suction Line High Stage=10° C.
Intermediate Heat Exchanger with indicated low stage refrigerant Condensing Temperature=0 C, 5° C. and 10° C.
Intermediate Heat Exchanger Superheat=3.3° C.
Difference in Temperature in Intermediate Heat Exchanger=8° C.

The performance results are reported in Table E18.

TABLE E18
Performance of Inventive Refrigerant Pairs in Cascade Refrigeration System

| | Refrigerant | | Efficiency @ | Efficiency @ | Efficiency @ |
|---|---|---|---|---|---|
| Example | Low Stage | high Stage | Tcond = 0° C. | Tcond = 5° C. | Tcond = 10° C. |
| CO2/R134a | CO2 | R134a | 100% | 100% | 100% |
| Baseline | | | | | |
| Ex. 18A | CO2 | R1234ze(E) | ~100% | 100% | 100% |
| Ex. 18B | CO2 | HDR165 | ~100% | 100% | 100% |
| Ex. 18C1 | CO2 | E2B | 100% | 100% | 100% |
| Ex. 18C | CO2 | E4 | 100% | 100% | 100% |
| Ex. 18D | Propane | R1234ze(E) | 107% | 110% | 114% |
| Ex. 18E1 | Propane | E2B | 107% | 110% | 114% |
| Ex. 18E | Propane | E4 | 107% | 110% | 114% |
| Ex. 18F | Propane | HDR165 | 107% | 110% | 114% |
| Ex. 18G | R1234yf | R1234ze(E) | 106% | 108% | 112% |
| Ex. 18H1 | R1234yf | E2B | 106% | 108% | 112% |
| Ex. 18H2 | R1234yf | E4 | 106% | 108% | 112% |
| Ex. 18I | R1234yf | HDR165 | 106% | 108% | 112% |
| Ex. 18J | R454C | R1234ze(E) | 106% | 109% | 113% |
| Ex. 18K1 | R454C | E2B | 106% | 109% | 113% |
| Ex. 18K2 | R454C | E4 | 106% | 109% | 113% |
| Ex. 18L | R454C | HDR165 | 106% | 109% | 113% |
| Ex. 18M | R455A | R1234ze(E) | 105% | 108% | 112% |
| Ex. 18N1 | R455A | E2B | 105% | 108% | 112% |
| Ex. 18N2 | R455A | E4 | 105% | 108% | 112% |
| Ex. 18O | R455A | HDR165 | 105% | 108% | 112% |

### Example 19: Micro-Cascade Refrigeration System

A micro-cascade system combines a traditional medium temperature DX refrigeration system, with or without suction line liquid line heat exchanger (SLHX). In this example, the advantageous combination of inventive pairs of refrigerants in the high stage and the low stage as indicated in Table 19 below are tested. The low stage comprises several small low temperature self-contained refrigeration systems is used. For the purposes of comparison, a base-line system operating with R-404A operating in the high stage and in the low stage is also tested.

Operating Conditions:

Baseline R404A Combined MT and LT (Non-Micro) System
Refrigeration Capacity
   Low Temperature: 33,000W
   Medium Temperature: 67,000W
Volumetric efficiency: 95% for both MT ad LT
Compressor Isentropic efficiency
   Medium Temperature=70% and Low Temperature=67%
Condensing temperature: 105° F.
Medium Temperature evaporation temperature: 20° F.
Low Temperature evaporation temperature: −20° F. Evaporator superheat: 10° F. (both Medium and Low Temperature)
Suction line temperature rise (due to heat transfer to surroundings)
   Baseline: Medium Temperature: 25° F.; Low Temperature: 50° F.
   Cascade/self-contained without SLHX: Medium Temperature: 10° F.; Low Temperature: 25° F.
   Cascade/self-contained with SLHX: Medium Temperature: 10° F.; Low Temperature: 15° F.
SLHX efficiency when used: 65%

The performance results are reported in Table E19.

TABLE E19
Comparison between R404A in the low stage and high
stage and Inventive Pairs of Refrigerants in the
High Stage and Low Stage of a micro-cascade system

| | | | Efficiency |
|---|---|---|---|
| | Refrigerant | | relative |
| Example | Low Stage | High Stage | to R404A |
| Comparative | R404A | R404A | 100% |
| Ex. 19A | CO2 | R1234ze(E) | 122% |
| Ex. 19B | CO2 | HDR165 | 122% |
| Ex. 19C1 | CO2 | E2B4 | 122% |
| Ex. 19C2 | CO2 | E4 | 122% |
| Ex. 19D | Propane | R1234ze(E) | 127% |
| Ex. 19E | Propane | HDR165 | 127% |
| Ex. 19F1 | Propane | E2B | 127% |
| Ex. 19F2 | Propane | E4 | 127% |
| Ex. 19G | R1234yf | R1234ze(E) | 126% |
| Ex. 19H | R1234yf | HDR165 | 126% |
| Ex. 19I1 | R1234yf | E2B | 126% |
| Ex. 19I2 | R1234yf | E4 | 126% |
| Ex. 19J | R454C | R1234ze(E) | 126% |
| Ex. 19K | R454C | HDR165 | 126% |
| Ex. 19L1 | R454C | E2B | 126% |
| Ex. 19L2 | R454C | E4 | 126% |
| Ex. 19M | R455A | R1234ze(E) | 126% |
| Ex. 19N | R455A | HDR165 | 126% |
| Ex. 19O1 | R455A | E2B | 126% |
| Ex. 19O2 | R455A | E4 | 126% |

The Table E19 above shows that the micro-cascade system using the inventive pairs of refrigerants according to the invention has at least about 120% higher COP than a baseline medium temperature DX system with R404A

What is claimed is:

1. A refrigerant consisting essentially of:
a. from about 74% to about 86% by weight of HFO-1234ze(E),
b. from greater than 4% to less than 11% by weight of HFC-134a; and
c. from greater than 4% to about 16% by weight of HFO-1224yd(Z).

2. The refrigerant of claim 1 comprising from 5% to 10% by weight of HFC-134a.

3. The refrigerant of claim 1 consisting essentially of:
a. from 75% to 86% by weight of HFO-1234ze(E),
b. about 10% or less by weight of HFC-134a; and
c. from 5% to about 16% by weight of HFO-1224yd(Z).

4. The refrigerant of claim 1 consisting essentially of:
a. from about 76% to about 84% by weight of HFO-1234ze(E),
b. 11% or less by weight of HFC-134a; and
c. from 4% to about 14% by weight of HFO-1224yd(Z).

5. The refrigerant of claim 1 consisting essentially of:
a. from about 78% to about 84% by weight of HFO-1234ze(E),
b. 11% or less by weight of HFC-134a; and
c. from about 4% to about 12% by weight of HFO-1224yd(Z).

6. The refrigerant of claim 1 consisting essentially of:
a. 83.5%+0.5/−2% by weight of HFO-1234ze(E),
b. 10%+2/−0.5% by weight of HFC-134a; and
c. 6.5%+2/−0.5% by weight of HFO-1224yd(Z).

7. The refrigerant of claim 1 having an evaporator glide of less than 4° C., a GWP of less than 150 and a flammability classification of A1.

8. A method of providing heating and/or cooling comprising:
a. providing a vapor compression refrigeration system comprising a compressor, a condenser, an evaporator and a refrigerant comprising:
i. from about 74% to less than 87% by weight of HFO-1234ze(E),
ii. from greater than 4% to less than 11% by weight of HFC-134a; and
iii. from greater than 3% to about 16% by weight of HFO-1224yd(Z).
b. evaporating said refrigerant in said evaporator, wherein the glide of said refrigerant in said evaporator is less than 4.5° C. and wherein said refrigerant has a capacity in said system that is greater than 65% of the capacity of R-134a in said system.

9. A cascade refrigeration system, comprising:
(f) a low stage refrigeration circuit comprising:
a low stage refrigerant having a GWP of about 150 or less; and
a compressor;
(g) an inter-circuit heat exchanger in which said low stage refrigerant condenses; and
(h) a high stage refrigeration circuit comprising a high stage refrigerant which: (i) has a Class A1 or a Class A2L flammability; and (ii) evaporates at a temperature below said low stage refrigerant condensing temperature; and (iii) comprises at least about 74% by weight of HFO-1234ze(E), wherein said high stage refrigerant evaporates in said inter-circuit heat exchanger by absorbing heat from said refrigerant in said low stage refrigeration circuit.

10. The cascade refrigeration system of claim 9 wherein said low stage refrigerant is a Class A1 or a Class A2L refrigerant.

11. The cascade refrigeration system of claim 9 wherein said high stage refrigerant is a Class A1 refrigerant.

12. The cascade refrigeration system of claim 9 wherein said high stage refrigerant comprises at least about 75% by weight of HFO-1234ze(E) and from about 5% to less than 12% of HFC-134a.

13. The cascade refrigeration system of claim 12 wherein said low stage refrigerant comprises one or more of CO2, propane, HFO-1234yf, R454C and R455A.

14. The cascade refrigeration system of claim 9 wherein said low stage refrigeration circuit comprises a plurality of low temperature refrigeration circuits.

15. The cascade refrigeration system of claim 14 wherein said low stage refrigerant condenses in said inter-circuit heat exchanger within the range of temperatures of from about −5° C. to about −15° C.

16. The cascade refrigeration system of claim 9 wherein said high stage refrigerant comprises 76% to 86% by weight of HFO-1234ze(E), from 4% to 16% by weight of HFO-1224yd(Z), and from about 5% to not greater than 11% by weight of HFC-134a.

17. The cascade refrigeration system of claim 16 wherein said low stage refrigerant condenses in said inter-circuit heat exchanger within the range of temperatures of from about −5° C. to about −15° C.

18. The cascade refrigeration system of claim 17 wherein said low stage refrigerant comprises one or more of CO2, propane, HFO-1234yf, R454C and R455A.

19. The cascade refrigeration system of claim 18 wherein said low stage refrigeration circuit comprises a plurality of self-contained low temperature refrigeration circuits.

20. A commercial refrigeration system comprising the cascade refrigeration system of claim 18.
